(19) United States
(12) Patent Application Publication
(10) Pub. No.: US 2006/0126751 A1
(43) Pub. Date: Jun. 15, 2006

(54) Technique for disparity bounding coding in a multi-level signaling system

(76) Inventor: Anthony Bessios, Fremont, CA (US)

Correspondence Address: HUNTON & WILLIAMS LLP/RAMBUS INC.;INTELLECTUAL PROPERTY DEPARTMENT, 1900 K STREET, N.W., SUITE 1200, WASHINGTON, DC, 20006-1109, US

(21) Appl. No.: 11/008,665

(22) Filed: Dec. 10, 2004

(51) Int. Cl. H04L 5/12; H04B 14/04

(52) U.S. Cl. 375/264; 375/242

(57) ABSTRACT

A technique for coding information for transmission in a multi-level signaling system is disclosed. In one particular exemplary embodiment, the technique may be realized as a method for coding information for transmission in a multi-level signaling system. The method comprises receiving information organized into multiple information sets, mapping the received information according to the contents of each information set, and changing a current weight polarity of the mapped information based at least in part upon an accumulated weight polarity of previously encoded information so as to provide a substantially DC balanced codeword that is substantially DC balanced for transmission in a multi-level signaling system.

### FIELD OF THE DISCLOSURE

The present disclosure relates generally to multi-level signaling and, more particularly, to a technique for disparity bounding coding in a multi-level signaling system.

### BACKGROUND OF THE DISCLOSURE

High-speed serial link channels delivering an effective data rate above 5 Gb/s in a backplane environment are subject to significant signal distortion due to inter-symbol interference (ISI). Transmitters and receivers need to compensate for most of the signal distortion using very low complexity schemes in order to obtain a target bit error rate (BER) of less than or equal to 10⁻¹⁷ at Gb/s rates and under severe power and complexity restrictions. This constrained space presents significant challenges to well-known signal processing and coding techniques, and sub-optimal but efficient alternatives are sometimes needed to fulfill the task.

Attenuation caused by conductor and dielectric losses causes dispersion ISI. Another important ISI component is reflections, which are essentially multipath components of a signal and originate from impedance discontinuities such as those caused by connectors of line cards at both transmit and receive ends. In addition to ISI distortion, cross-talk effects from far and near end adjacent channels is becoming increasingly significant.

To counteract channel attenuation at high bit rates, conventional 2-level pulse amplitude modulation (2-PAM) signaling may be replaced by other multi-level signaling schemes that utilize more than two signal levels. That is, in a 2-PAM signaling system, each conductor in the system may carry signals at one of two signal levels (i.e., at either a logic zero level or a logic one level). Thus, in a 2-PAM signaling system, each conductor in the system can only transmit one bit of data per bit time. However, in a 4-level pulse amplitude modulation (4-PAM) signaling system, for example, each conductor in the system may carry signals at four different signal levels (i.e., four different symbols). Thus, in a 4-PAM signaling system, each conductor in the system can transmit two bits of data simultaneously at one half the symbol rate for an equivalent bandwidth.

In order to preserve the advantages of signaling systems that utilize more than two signal levels over 2-PAM signaling, it is desirable to secure a minimum density of desirable symbol transitions useful for clock data recovery (CDR) operations. These CDR transitions prevent continuous phase drifting from an optimum sampling point at the center of an eye in plesiochronous systems with frequency offsets between received data and a local receive clock.

It is also desirable to provide a DC balancing property to transmitted information in a multi-level signaling system since such a property would further limit signal distortion due to ISI.

In view of the foregoing, it would be desirable to provide a coding technique for use in a multi-level signaling system which incorporates at least some of the above-mentioned desirable qualities.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 shows a complete transition diagram for a 4-PAM signaling system.

FIG. 2 shows a first group of symbol transitions which are desirable for use in clock data recovery (CDR) in a 4-PAM signaling system.

FIG. 3 shows a second group of symbol transitions which are not desirable for use in CDR in a 4-PAM signaling system.

FIG. 4 shows a 4-PAM signaling system in accordance with an embodiment of the present disclosure.

FIG. 5 shows an exemplary embodiment of the encoder shown in FIG. 4 in accordance with an embodiment of the present disclosure.

FIG. 6 shows an exemplary embodiment of the 32s34s encoder shown in FIG. 5 in accordance with an embodiment of the present disclosure.

FIG. 7 lists the operation steps followed by the mapper shown in FIG. 6 when at least one of eight 8-bit bytes in a scrambled or unscrambled version of parallel control/data information contains control information in accordance with an embodiment of the present disclosure.

FIG. 8 shows an exemplary illustration of how the mapper shown in FIG. 6 operates to generate mapped parallel control/data information when at least one of eight 8-bit bytes in a scrambled or unscrambled version of parallel control/data information contains control information in accordance with an embodiment of the present disclosure.

FIG. 9 contains a table which illustrates exemplary values for use in a control chain pointer field in mapped parallel control/data information in accordance with an embodiment of the present disclosure.

FIG. 10 contains a table which illustrates exemplary values for use in a control value field in mapped parallel control/data information in accordance with an embodiment of the present disclosure.

FIG. 11 lists the operation steps followed by the mapper shown in FIG. 6 when all eight 8-bit bytes in a scrambled or unscrambled version of parallel control/data information contain data information in accordance with an embodiment of the present disclosure.

FIG. 12 shows an exemplary illustration of how the mapper shown in FIG. 6 operates to generate mapped parallel control/data information when all eight 8-bit bytes in a scrambled or unscrambled version of parallel control/data information contain data information in accordance with an embodiment of the present disclosure.

FIG. 13 shows an exemplary embodiment of the mapper shown in FIG. 6 in accordance with an embodiment of the present disclosure.

FIG. 14 shows an exemplary embodiment of the control base pointer calculator shown in FIG. 13 in accordance with an embodiment of the present disclosure.

FIG. 15A shows an exemplary embodiment of the control chain pointer calculator shown in FIG. 13 in accordance with an embodiment of the present disclosure.

FIG. 15B shows an exemplary mapping table for the control chain pointer calculator shown in FIG. 15A in accordance with an embodiment of the present disclosure.

FIG. 16 shows an exemplary embodiment of the mapped parallel control/data information assembler shown in FIG. 13 in accordance with an embodiment of the present disclosure.

FIG. 17 shows an exemplary embodiment of the data base pointer calculator shown in FIG. 13 in accordance with an embodiment of the present disclosure.

FIG. 18 shows an exemplary embodiment of one of the plurality of data base pointer assignors shown in FIG. 17 in accordance with an embodiment of the present disclosure.

FIG. 19 shows an exemplary embodiment of the control value comparator shown in FIG. 18 in accordance with an embodiment of the present disclosure.

FIG. 20 shows an exemplary embodiment of the control chain pointer comparator shown in FIG. 18 in accordance with an embodiment of the present disclosure.

FIG. 21 shows an exemplary embodiment of the DC balancer shown in FIG. 6 in accordance with an embodiment of the present disclosure.

FIG. 22 shows an exemplary embodiment of the current/accumulated weight polarity sign generator shown in FIG. 21 in accordance with an embodiment of the present disclosure.

FIG. 23 shows an exemplary embodiment of the polarity reversal circuit shown in FIG. 21 in accordance with an embodiment of the present disclosure.

FIG. 24 shows an exemplary embodiment of the decoder shown in FIG. 4 in accordance with an embodiment of the present disclosure.

FIG. 25 shows an exemplary embodiment of the 32s34s decoder shown in FIG. 24 in accordance with an embodiment of the present disclosure.

FIG. 26 shows an exemplary embodiment of one of the pair of control chain pointer decoders shown in FIG. 25 in accordance with an embodiment of the present disclosure.

FIG. 27 shows an exemplary embodiment of one of the plurality of control chain pointer decoder logic circuits shown in FIG. 26 in accordance with an embodiment of the present disclosure.

FIG. 28 shows an exemplary embodiment of the control base pointer identification logic shown in FIG. 27 in accordance with an embodiment of the present disclosure.

FIG. 29 shows an exemplary embodiment of the control validation logic shown in FIG. 27 in accordance with an embodiment of the present disclosure.

FIG. 30 shows an exemplary embodiment of the pointed byte logic shown in FIG. 29 in accordance with an embodiment of the present disclosure.

FIG. 31 shows an exemplary embodiment of the control base pointer validation logic shown in FIG. 27 in accordance with an embodiment of the present disclosure.

FIG. 32 shows an exemplary embodiment of the control chain pointer identification logic shown in FIG. 27 in accordance with an embodiment of the present disclosure.

FIG. 33 shows an exemplary embodiment of the termination logic shown in FIG. 32 in accordance with an embodiment of the present disclosure.

FIG. 34 shows an exemplary embodiment of the control chain pointer end confirmation logic shown in FIG. 27 in accordance with an embodiment of the present disclosure.

FIG. 35 shows an exemplary embodiment of one of the plurality of demapped parallel control/data information assemblers shown in FIG. 26 in accordance with an embodiment of the present disclosure.

FIG. 36 shows a chart listing the conditions required for activating an error output information signal (ed) in accordance with an embodiment of the present disclosure.

FIG. 37 shows an exemplary embodiment of the error detection logic shown in FIG. 26, which operates in accordance with the conditions set forth in the chart of FIG. 36, in accordance with an embodiment of the present disclosure.

FIG. 38 shows an exemplary embodiment of the error detected logic circuit shown in FIG. 37 in accordance with an embodiment of the present disclosure.

### DETAILED DESCRIPTION OF EXEMPLARY EMBODIMENT(S)

A technique for coding information for transmission in a multi-level signaling system is disclosed. In one particular exemplary embodiment, the technique may be realized as a method for coding information for transmission in a multi-level signaling system. The method may comprise receiving information organized into multiple information sets, mapping the received information according to the contents of each information set, and changing a current weight polarity of the mapped information based at least in part upon an accumulated weight polarity of previously encoded information so as to provide a substantially DC balanced codeword that is substantially DC balanced for transmission in a multi-level signaling system.

In another particular exemplary embodiment, the technique may be realized as an apparatus for coding information for transmission in a multi-level signaling system. The apparatus may comprise a mapper configured to map received information organized into multiple information sets according to the contents of each information set, and a DC balancer configured to change a current weight polarity of the mapped information based at least in part upon an accumulated weight polarity of previously encoded information so as to provide a substantially DC balanced codeword that is substantially DC balanced for transmission in a multi-level signaling system.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

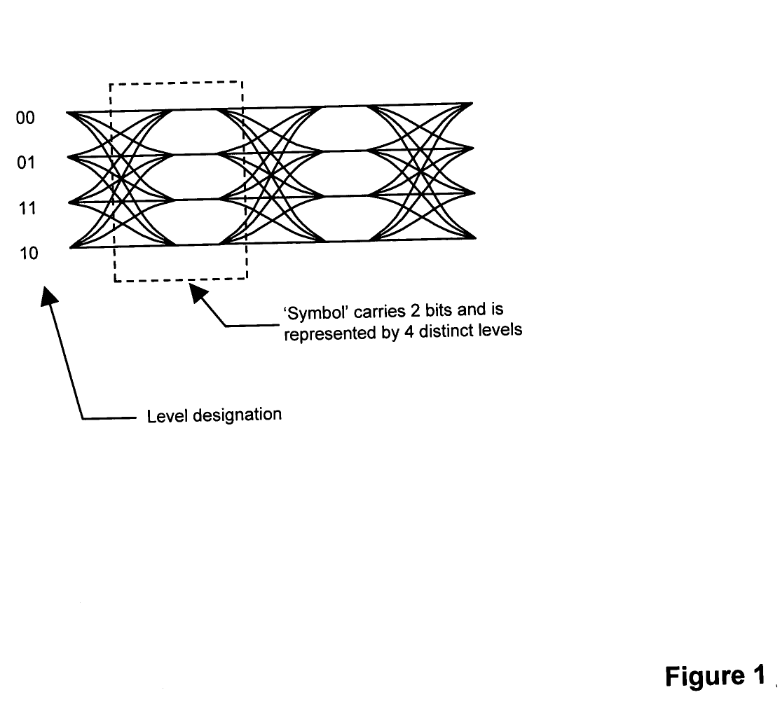

Referring to FIG. 1, there is shown a complete transition diagram for a 4-PAM signaling system. This diagram shows all of the possibilities of how a signal at a given signal level may transition to another signal level between adjacent symbols. There are 16 distinct transitions between symbols, including no transition at all.

The signal level designations shown in FIG. 1 are such that a two-bit binary value is assigned to each signal level (e.g., a Gray code assignment). Each sequential symbol carries this two-bit binary value in a 4-PAM signaling system. It should be noted, however, that the present disclosure is not limited to 4-PAM signaling systems or to signal level designations having Gray code assignments.

At this point it should be noted that the binary signal level designations shown in FIG. 1 may be associated with many different combinations of signal voltage, current, or other unit levels. For example, in a very simplified case, the 00 binary signal level designation may be associated with +0.500 volts, the 01 binary signal level designation may be associated with +0.167 volts, the 11 binary signal level designation may be associated with −0.167 volts, and the 10 binary signal level designation may be associated with −0.500 volts. Of course, the present disclosure is not limited in this regard since, as mentioned above, the binary signal level designations shown in FIG. 1 may be associated with many different combinations of signal voltages. The present disclosure may also be helpful in systems in which the signal level designations are expressed in terms of current, or other unit, levels. In some instances, it is useful to express the binary signal level designations using unitless values which are representative of normalized amplitudes of voltages associated with the binary signal level designations. For example, in a 4-PAM signaling system, the binary signal level designations may be expressed as −3, −1, +1, and +3. Expressing the binary signal level designations in this manner facilitates expressing the sum of the levels and differences between levels as integer values.

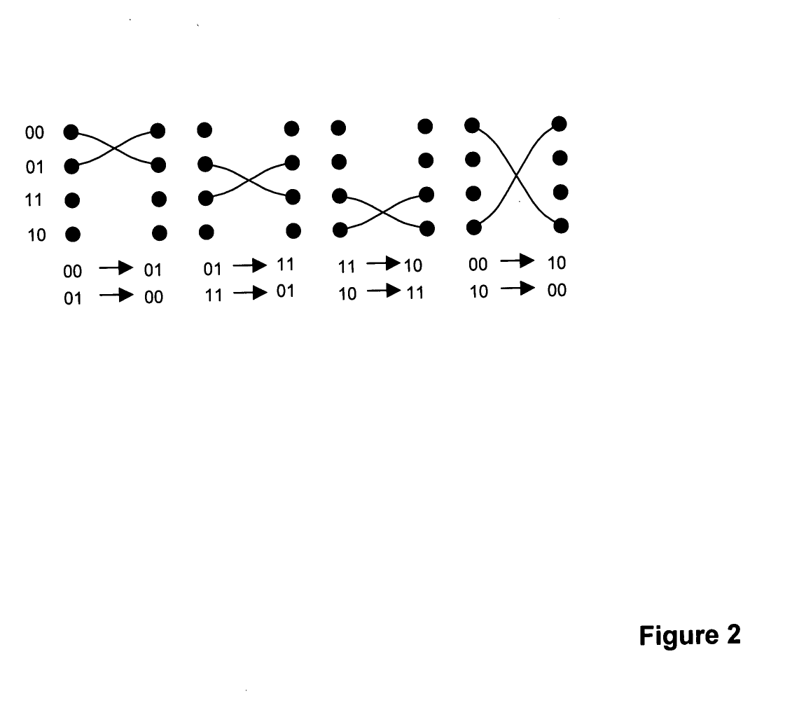

Referring to FIG. 2, there is shown a first group of symbol transitions which are desirable for use in clock data recovery (CDR) in a 4-PAM signaling system. These symbol transitions are desirable because the crossing point of each of the waveforms is geometrically centered between symbols. Each of these symbol transitions has a property where only the most significant bit (MSB) or the least significant bit (LSB) changes from one symbol to the next. This holds true for at least the numeric assignment given to each signal level used in this detailed description. The small MSB symbol transitions are the most desirable since their presence may alleviate the need to estimate an offset for samplers. Providing a quantity of transitions suitable for CDR is an objective of the disparity bounding coding technique described herein. Providing a DC balancing property to transmitted information in a multi-level signaling system is also an objective of the disparity bounding coding technique described herein, as described in detail below.

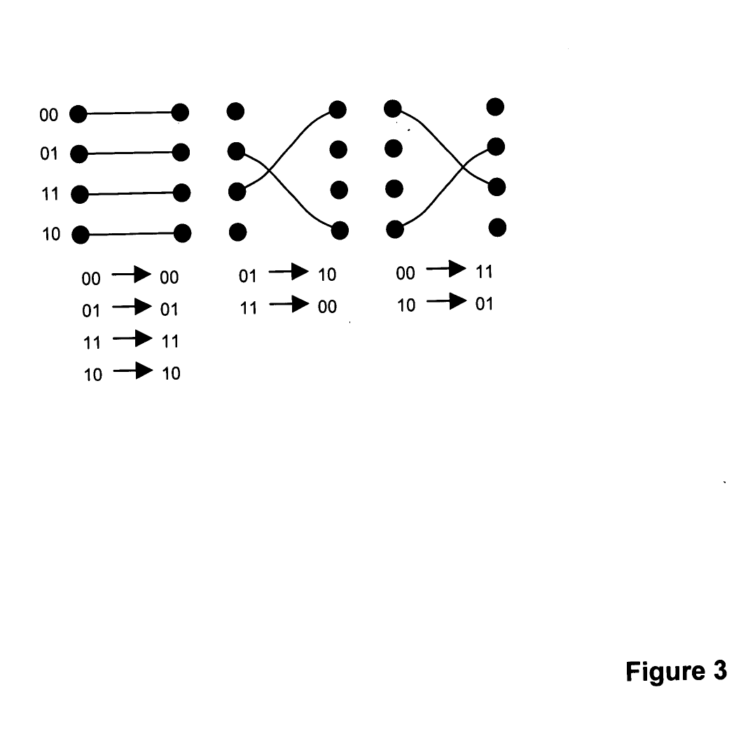

Referring to FIG. 3, there is shown a second group of symbol transitions which are not desirable for use in CDR in a 4-PAM signaling system. The four symbol transitions having no value change cannot be used for CDR at all. The remaining four symbol transitions are not desirable because the crossing point of each of the waveforms is offset to either side of the geometric center between symbols. CDR using these symbol transitions would pull the optimal sampling point away from the geometric center, potentially in a data dependent manner.

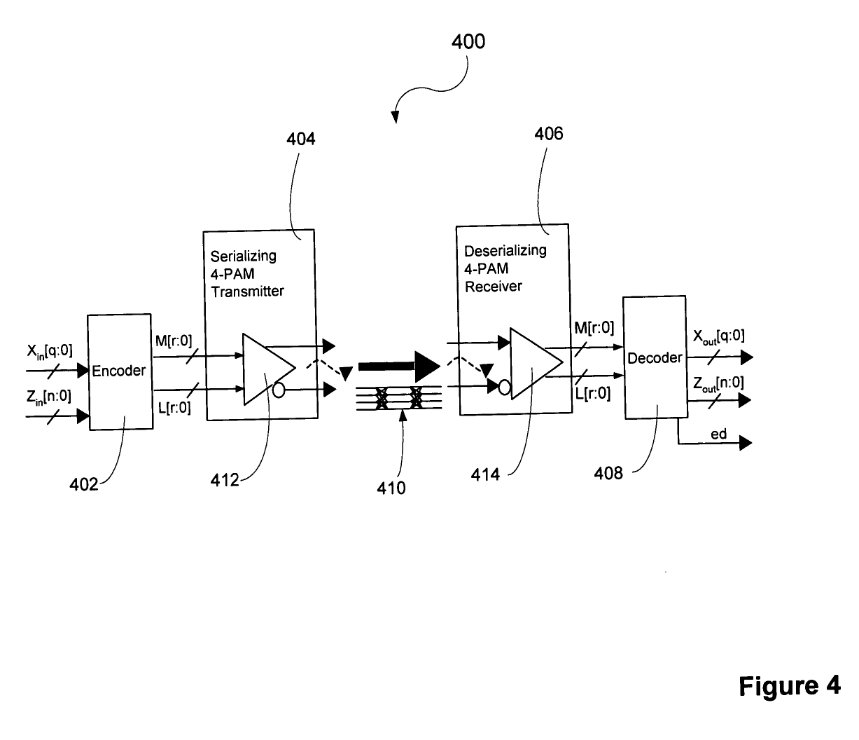

Referring to FIG. 4, there is shown a 4-PAM signaling system 400 in accordance with an embodiment of the present disclosure. The 4-PAM signaling system 400 comprises an encoder 402, a serializing 4-PAM transmitter 404, a deserializing 4-PAM receiver 406, and a decoder 408. The serializing 4-PAM transmitter 404 and the deserializing 4-PAM receiver 406 are interconnected by a pair of signal carrying conductors 410.

In the embodiment of FIG. 4, the encoder 402 receives parallel control/data input information (Xᵢₙ[q:0]), and then encodes the received parallel control/data input information (Xᵢₙ[q:0]) so as to provide parallel codewords to the serializing 4-PAM transmitter 404 that are organized as MSB codewords (M[r:0]) and LSB codewords (L[r:0]). The MSB codewords (M[r:0]) and the LSB codewords (L[r:0]) together include multiple consecutive symbols. The parallel control/data input information (Xᵢₙ[q:0]) is received as a word having q+1 bits. The MSB codewords (M[r:0]) and the LSB codewords (L[r:0]) each have r+1 bits. The encoder 402 may be implemented with binary logic.

At this point it should be noted that the encoder 402 also receives parallel control/data indicator input information (Zᵢₙ[n:0]), which indicates whether the parallel control/data input information (Xᵢₙ[q:0]) is comprised of control (K) control and/or data (D) information. The parallel control/data indicator input information (Zᵢₙ[n:0]) is received as a word having n+1 bits. The parallel control/data indicator input information (Zᵢₙ[n:0]) is used in the operation of the encoder 402, as described in more detail below.

The serializing 4-PAM transmitter 404 receives the MSB codewords (M[r:0]) and the LSB codewords (L[r:0]) in parallel form from the encoder 402. The serializing 4-PAM transmitter 404 comprises a differential transmitter 412 for differentially serially transmitting the received multiple consecutive symbols in the MSB codewords (M[r:0]) and the LSB codewords (L[r:0]) over the pair of signal carrying conductors 410 to the deserializing 4-PAM receiver 406.

The deserializing 4-PAM receiver 406 comprises a differential receiver 414 for differentially serially receiving the multiple consecutive symbols in the MSB codewords (M[r:0]) and the LSB codewords (L[r:0]) over the pair of signal carrying conductors 410 from the serializing 4-PAM transmitter 404. The differential receiver 414 then transmits the MSB codewords (M[r:0]) and the LSB codewords (L[r:0]) in parallel form to the decoder 408.

The decoder 408 is essentially the inverse of the encoder 402. That is, the decoder 408 receives the MSB codewords (M[r:0]) and the LSB codewords (L[r:0]) in parallel form from the deserializing 4-PAM receiver 406, and then decodes the received MSB codewords (M[r:0]) and the received LSB codewords (L[r:0]) so as to provide parallel control/data output information (Xₒᵤₜ[q:0]). The parallel control/data output information (Xₒᵤₜ[q:0]) is provided as a word having q+1 bits. The decoder 408 may be implemented with binary logic.

At this point it should be noted that the decoder 408 also provides parallel control/data indicator output information (Zₒᵤₜ[n:0]), which indicates whether the parallel control/data output information (Xₒᵤₜ[q:0]) is comprised of control (K) information and/or data (D) information. The parallel control/data indicator output information (Zₒᵤₜ[n:0]) is provided as a word having n+1 bits. The parallel control/data indicator output information (Zₒᵤₜ[n:0]) is used in the operation of the decoder 408, as described in more detail below.

At this point it should be noted that the decoder 408 further provides an error output information signal (ed), which indicates whether any errors have been detected in the parallel control/data output information (Xₒᵤₜ[q:0]), as described in more detail below.

At this point it should be noted that, while FIG. 4 shows the serializing 4-PAM transmitter 404 as having the differential transmitter 412 and the deserializing 4-PAM receiver 406 as having the differential receiver 414, the present disclosure is not limited in this regard. That is, the MSB codewords (M[r:0]) and the LSB codewords (L[r:0]) may be transmitted from the serializing 4-PAM transmitter 404 to the deserializing 4-PAM receiver 406 in a single-ended manner requiring only a single-ended transmitter and a single-ended receiver. Thus, the serializing 4-PAM transmitter 404 and the deserializing 4-PAM receiver 406 may alternatively be interconnected by a single signal carrying conductor instead of the pair of signal carrying conductors 410. Alternatively still, in an optical based system, the serializing 4-PAM transmitter 404 and the deserializing 4-PAM receiver 406 may be interconnected by an optical fiber capable carrying signals at multiple optical signal levels. Alternatively even still, in a wireless based system, the serializing 4-PAM transmitter 404 and the deserializing 4-PAM receiver 406 may not be interconnected by any fixed transmission medium, but rather the MSB codewords (M[r:0]) and the LSB codewords (L[r:0]) may be transmitted from the serializing 4-PAM transmitter 404 to the deserializing 4-PAM receiver 406 via a wireless protocol.

For purposes of clearly describing the present disclosure, assume that the 4-PAM signaling system 400 shown in FIG. 4 is utilizing a 32-symbol to 34-symbol (32s34s) disparity bounding coding technique in accordance with an embodiment of the present disclosure. Thus, in the embodiment of FIG. 4, the encoder 402 receives parallel control/data input information (Xᵢₙ[63:0]), and then encodes the received parallel control/data input information (Xᵢₙ[63:0]) so as to provide parallel codewords to the serializing 4-PAM transmitter 404 that are organized as MSB codewords (M[33:0]) and LSB codewords (L[33:0]). The parallel control/data input information (Xᵢₙ[63:0]) is received as an 64-bit word. The MSB codewords (M[33:0]) and the LSB codewords (L[33:0]) each have 34 bits, wherein each MSB codeword (M[33:0]) has 34 codeword bits organized as [C₆₆, C₆₄, C₆₂, . . . C₀] and each LSB codeword (L[33:0]) has 34 codeword bits organized as [C₆₇, C₆₅, C₆₃, . . . C₁]. Thus, the MSB codewords (M[33:0]) and the LSB codewords (L[33:0]) together form 68-bit codewords (i.e., C₆₇, C₆₆, C₆₅, . . . C₀) that are represented by groups of consecutive 2-bit symbols (i.e., C₆₇ & C₆₆, C₆₅ & C₆₄, C₆₃ & C₆₂, . . . C₁ & C₀).

Assume also that the parallel control/data input information (Xᵢₙ[63:0]), which is received as an 64-bit word, is organized into eight 8-bit bytes. Thus, in the embodiment of FIG. 4, the encoder 402 receives parallel control/data indicator input information (Zᵢₙ[7:0]), wherein each bit of the parallel control/data indicator input information (Zᵢₙ[7:0]) corresponds to a respective byte of the parallel control/data input information (Xᵢₙ[63:0]). The logic state of each bit of the parallel control/data indicator input information (Zᵢₙ[7:0]) indicates whether a respective byte of the parallel control/data input information (Xᵢₙ[63:0]) is comprised of control (K) information or data (D) information. For example, if a bit of the parallel control/data indicator input information (Zᵢₙ[7:0]) is a logic “0”, then the respective byte of the parallel control/data input information (Xᵢₙ[63:0]) is comprised of data (D) information. Alternatively, if a bit of the parallel control/data indicator input information (Zᵢₙ[7:0]) is a logic “1”, then the respective byte of the parallel control/data input information (Xᵢₙ[63:0]) is comprised of control (K) information.

Analogously, assuming that the 4-PAM signaling system 400 shown in FIG. 4 is utilizing a 32s34s disparity bounding coding technique in accordance with an embodiment of the present disclosure, the decoder 408 receives the MSB codewords (M[33:0]) and the LSB codewords (L[33:0]) in parallel form, and then decodes the received MSB codewords (M[33:0]) and the received LSB codewords (L[33:0]) so as to provide parallel control/data output information (Xₒᵤₜ[63:0]). Assuming that the parallel control/data output information (Xₒᵤₜ[63:0]), which is provided as a 64-bit word, is organized into eight 8-bit bytes, the decoder 408 also provides parallel control/data indicator output information (Zₒᵤₜ[7:0]), wherein each bit of the parallel control/data indicator output information (Zₒᵤₜ[7:0]) corresponds to a respective byte of the parallel control/data output information (Xₒᵤₜ[63:0]). The logic state of each bit of the parallel control/data indicator output information (Zₒᵤₜ[7:0]) indicates whether a respective byte of the parallel control/data output information (Xₒᵤₜ[63:0]) is comprised of control (K) information or data (D) information. For example, if a bit of the parallel control/data indicator output information (Zₒᵤₜ[7:0]) is a logic “0”, then the respective byte of the parallel control/data output information (Xₒᵤₜ[63:0]) is comprised of data (D) information. Alternatively, if a bit of the parallel control/data indicator output information (Zₒᵤₜ[7:0]) is a logic “1”, then the respective byte of the parallel control/data output information (Xₒᵤₜ[63:0]) is comprised of control (K) information. The decoder 408 further provides the error output information signal (ed), which indicates whether any errors have been detected in the parallel control/data output information (Xₒᵤₜ[63:0]), as described in more detail below.

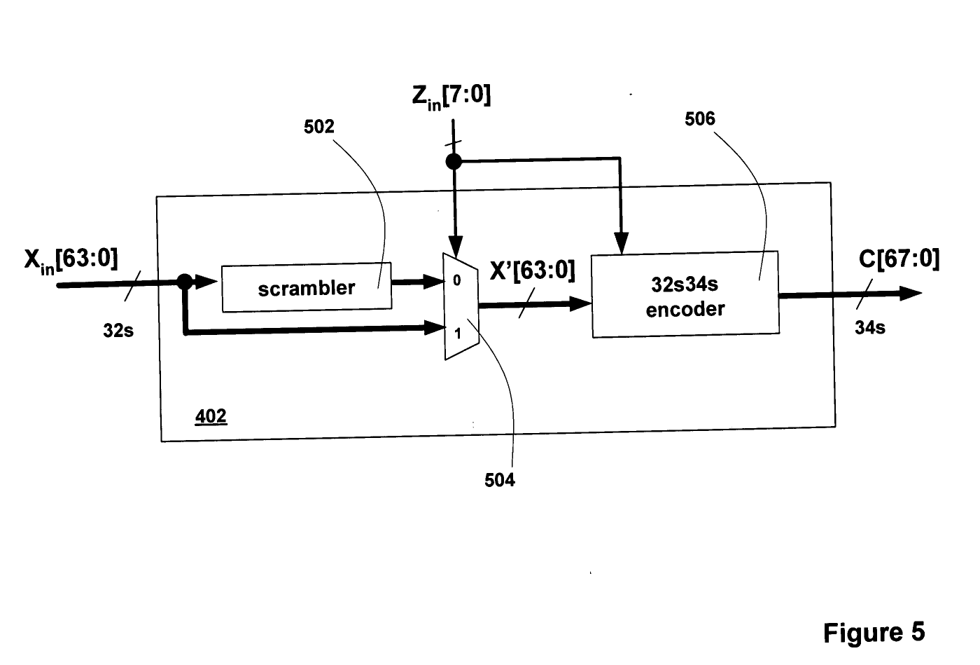

Referring to FIG. 5, there is shown an exemplary embodiment of the encoder 402 of FIG. 4. The encoder 402 comprises a scrambler 502, a multiplexer 504, and a 32s34s encoder 506. Assuming that the 4-PAM signaling system 400 shown in FIG. 4 is utilizing a 32s34s disparity bounding coding technique in accordance with an embodiment of the present disclosure, the encoder 402 receives the parallel control/data input information (Xᵢₙ[63:0]), which is passed both through and around the scrambler 502. The scrambler 502 operates to randomize the parallel control/data input information (Xᵢₙ[63:0]) that is passed therethrough, which is a common function in many code-based signaling systems. The multiplexer 504 operates to provide either a scrambled or unscrambled version of the parallel control/data information (X′[63:0]) to the 32s34s encoder 506, which operates to encode its received data using a 32s34s disparity bounding coding technique. Both the multiplexer 504 and the 32s34s encoder 506 are controlled via parallel control/data indicator input information (Zᵢₙ[7:0]), which indicates whether the parallel control/data input information (Xᵢₙ[63:0]) is carrying control (K) information and/or data (D) information, as described above.

The multiplexer 504 uses the parallel control/data indicator input information (Zᵢₙ[7:0]) to provide an unscrambled version of a byte of the parallel control/data information (X′[63:0]) to the 32s34s encoder 506 if the byte of the parallel control/data information (X′[63:0]) is carrying control (K) information. Otherwise, the multiplexer 504 uses the parallel control/data indicator input information (Zᵢₙ[7:0]) to provide a scrambled version of a byte of the parallel control/data information (X′[63:0]) to the 32s34s encoder 506 if the byte of the parallel control/data information (X′[63:0]) is carrying data (D) information.

The 32s34s encoder 506 uses the parallel control/data indicator input information (Zᵢₙ[7:0]) to encode the unscrambled control (K) information or the scrambled data (D) information accordingly, as described in detail below. The 32s34s encoder 506 provides 68-bit codewords (i.e., C[67:0]=(C₆₇, C₆₆, C₆₅, . . . C₀) to the serializing 4-PAM transmitter 404 that are organized as MSB codewords (M[33:0]) and LSB codewords (L[33:0]), as described above.

At this point it should be noted that the scrambler 502, and thus the multiplexer 504, are entirely optional in the encoder 402. That is, the encoder 402 may simply comprise the 32s34s encoder 506 for the 4-PAM signaling system 400 shown in FIG. 4 to operate utilizing a 32s34s disparity bounding coding technique in accordance with an embodiment of the present disclosure.

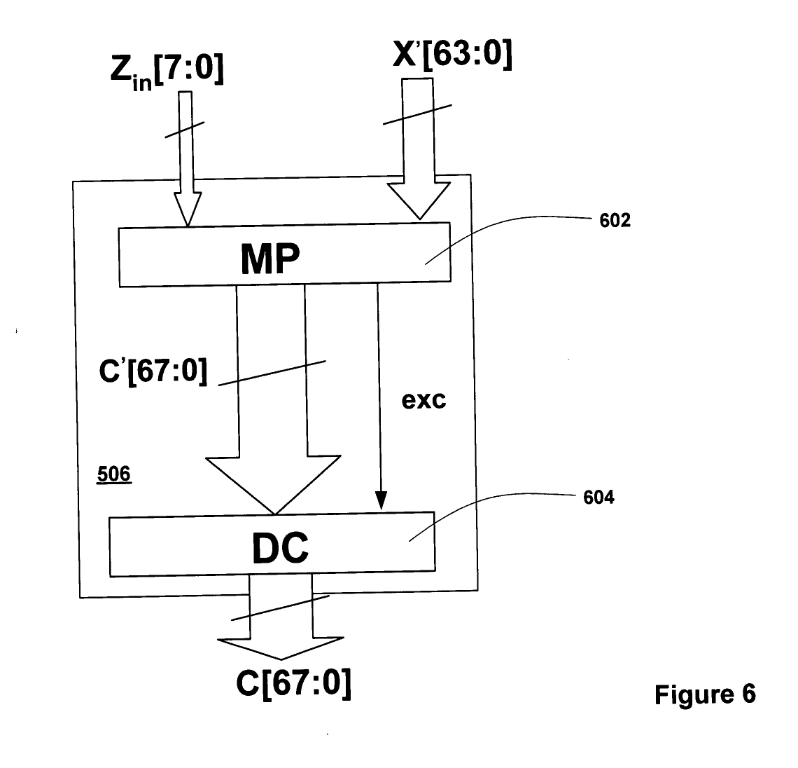

Referring to FIG. 6, there is shown an exemplary embodiment of the 32s34s encoder 506 of FIG. 5. The 32s34s encoder 506 comprises a mapper 602 and a DC balancer 604. Assuming that the 4-PAM signaling system 400 shown in FIG. 4 is utilizing a 32s34s disparity bounding coding technique in accordance with an embodiment of the present disclosure, the mapper 602 receives the parallel control/data indicator input information (Zᵢₙ[7:0]) and either a scrambled or unscrambled version of the parallel control/data information (X′[63:0]), and generates mapped parallel control/data information (C′[67:0]) based thereon. The mapper 602 also generates an exception signal (exc), which is active in limited exception cases, as described in detail below. A more detailed description of the overall operation of the mapper 602 is set forth below.

The DC balancer 604 receives the mapped parallel control/data information (C′[67:0]) and the exception signal (exc) from the mapper 602, and generates 68-bit codewords (i.e., C[67:0]=(C₆₇, C₆₆, C₆₅, . . . C₀) to the serializing 4-PAM transmitter 404 that are organized as MSB codewords (M[33:0]) and LSB codewords (L[33:0]), as described above. A more detailed description of the overall operation of the DC balancer 604 is set forth below.

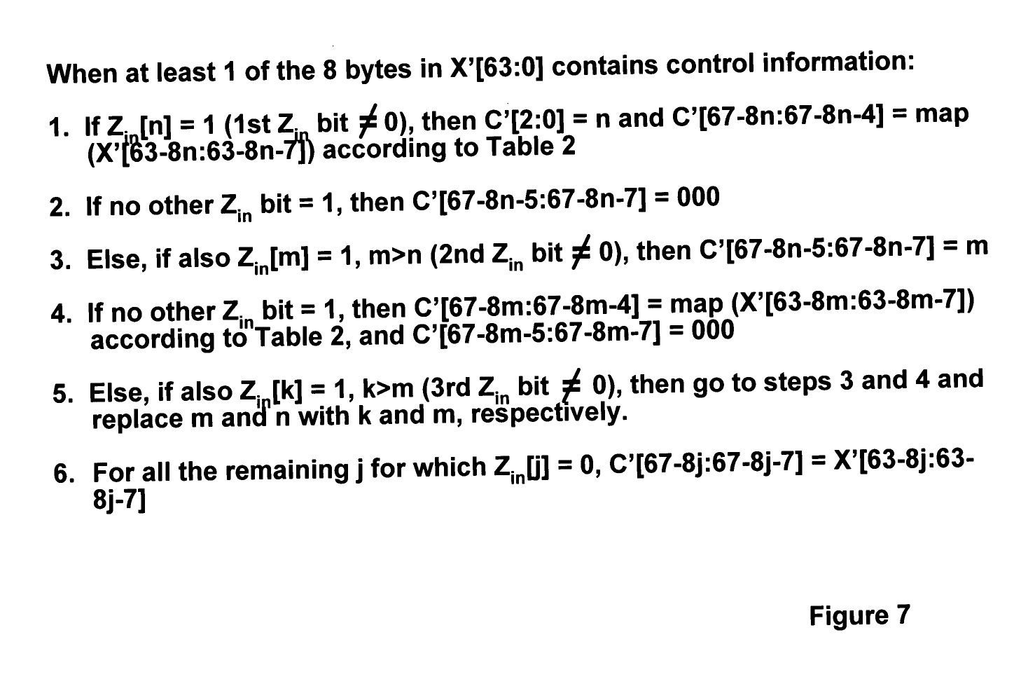

The mapper 602 operates to generate the mapped parallel control/data information (C′[67:0]) based primarily upon whether one or more bytes in the scrambled or unscrambled version of the parallel control/data information (X′[63:0]) contains control (K) information. For example, when at least one of the eight 8-bit bytes in the scrambled or unscrambled version of the parallel control/data information (X′[63:0]) contains control (K) information, the mapped parallel control/data information (C′[67:0]) is generated in accordance with the steps set forth in FIG. 7. In this case, the exception signal (exc) is always inactive.

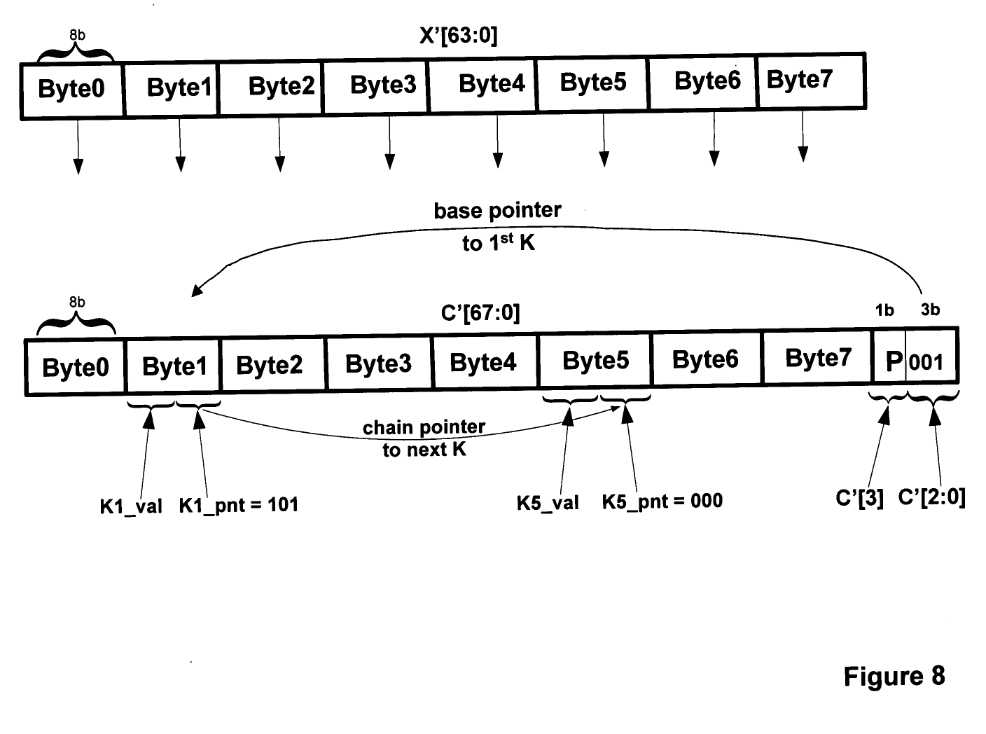

Referring to FIG. 8, there is shown an exemplary illustration of how the mapper 602 operates to generate the mapped parallel control/data information (C′[67:0]) when at least one of the eight 8-bit bytes in the scrambled or unscrambled version of the parallel control/data information (X′[63:0]) contains control (K) information. That is, FIG. 8 shows a representation of a partially scrambled or unscrambled version of the parallel control/data information (X′[63:0]) organized into eight 8-bit bytes. FIG. 8 also shows a representation of the mapped parallel control/data information (C′[67:0]), which includes the eight 8-bit bytes of the parallel control/data information (X′[63:0]), as well as four additional code bits for use in implementing a 32s34s disparity bounding coding technique in accordance with an embodiment of the present disclosure.

As shown in FIG. 8, three of the four additional code bits in the mapped parallel control/data information (C′[67:0]) may be used to provide a control base pointer field (C′[2:0]) for the mapped parallel control/data information (C′[67:0]), while the remaining one of the four additional code bits in the mapped parallel control/data information (C′[67:0]) may be used to provide a parity (P) bit (C′[3]) for the mapped parallel control/data information (C′[67:0]).

If there is a byte in the parallel control/data information (X′[63:0]) containing control (K) information, as indicated by the presence of a logic “1” in a respective bit of the parallel control/data indicator input information (Zᵢₙ[7:0]), then the control base pointer field (C′[2:0]) may be set to a value (Kn_pnt) which indicates the position of this “control” byte within the mapped parallel control/data information (C′[67:0]). If there is only one “control” byte in the parallel control/data information (X′[63:0]), then a control chain pointer field (Kn_pnt) within the one “control” byte within the mapped parallel control/data information (C′[67:0]) may be set to an end value (e.g., logic “000”), and the 32s34s disparity bounding coding technique may continue as described in detail below.

If there is more than one “control” byte in the parallel control/data information (X′[63:0]), then the control base pointer field (C′[2:0]) may be set to a value (Kn_pnt) which indicates the position of the first “control” byte within the mapped parallel control/data information (C′[67:0]), wherein the first “control” byte may be determined by the position of the first “control” byte within the parallel control/data information (X′[63:0]). For example, a first byte (i.e., byte 0) within the parallel control/data information (X′[63:0]) may include the top 8 bits (i.e., X′[63:56]) of the parallel control/data information (X′[63:0]), a second byte (i.e., byte 1) within the parallel control/data information (X′[63:0]) may include the next 8 bits (i.e., X′[55:48]) of the parallel control/data information (X′[63:0]), and so on until an eighth byte (i.e., byte 7) within the parallel control/data information (X′[63:0]), which includes the bottom 8 bits (i.e., X′[7:0]) of the parallel control/data information (X′[63:0]). Thus, as shown in FIG. 8, the first “control” byte within the parallel control/data information (X′[63:0]) may be the second byte (i.e., byte 1) within the parallel control/data information (X′[63:0]), and a second “control” byte within the parallel control/data information (X′[63:0]) may be the sixth byte (i.e., byte 5) within the parallel control/data information (X′[63:0]).

In accordance with the 32s34s disparity bounding coding technique of the present disclosure, the control chain pointer field (K1_pnt) within the first “control” byte (i.e., byte 1) of the mapped parallel control/data information (C′[67:0]) may be set to a value (e.g., logic “101”) which indicates the position of the second “control” byte (i.e., byte 5) within the parallel control/data information (X′[63:0]). Since, in the example illustrated in FIG. 8, the second “control” byte (i.e., byte 5) within the parallel control/data information (X′[63:0]) is the last “control” byte within the parallel control/data information (X′[63:0]), then the control chain pointer field (K5_pnt) within the second “control” byte (i.e., byte 5) within the mapped parallel control/data information (C′[67:0]) may be set to an end value (e.g., logic “000”), and the 32s34s disparity bounding coding technique may continue as described in detail below.

As shown in FIG. 8, each “control” byte in the mapped parallel control/data information (C′[67:0]) has a control value field (Kn_val). The control value field (Kn_val) in each “control” byte in the mapped parallel control/data information (C′[67:0]) may be set to a value (Kn_val) that insures at least one good CDR transition should be present in the mapped parallel control/data information (C′[67:0]), as described in detail below.

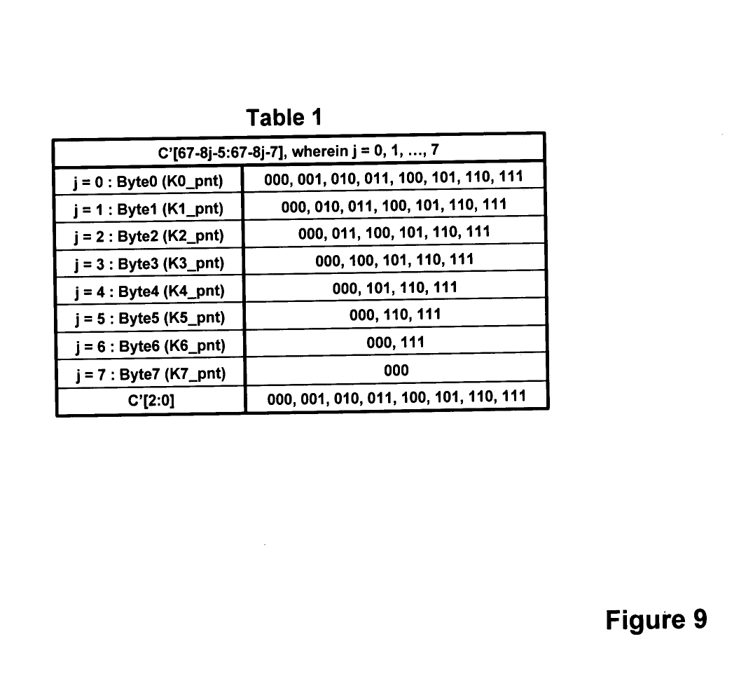

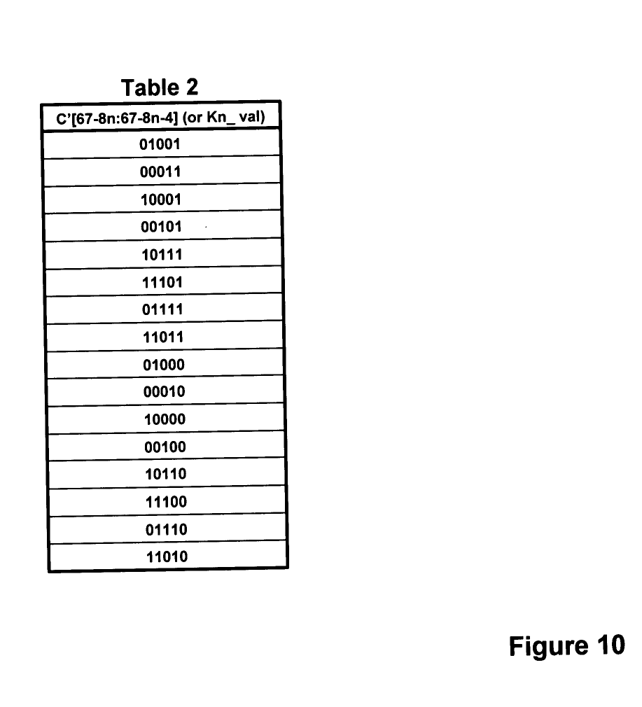

At this point it should be noted that Table 1 shown in FIG. 9 illustrates exemplary values (Kn_pnt) for use in the control chain pointer field (Kn_pnt) in the mapped parallel control/data information (C′[67:0]), while Table 2 shown in FIG. 10 illustrates exemplary values (Kn_val) for use in the control value field (Kn_val) in the mapped parallel control/data information (C′[67:0]). Any of the exemplary values (Kn_val) listed in Table 2 may be used in the control value field (Kn_val) in the mapped parallel control/data information (C′[67:0]), wherein n=0, 1, . . . 7.

At this point it should be noted that the number of “control” bytes within the parallel control/data information (X′[63:0]) is not limited to the first “control” byte (i.e., byte 1) and the second “control” byte (i.e., byte 5) as described above in the example illustrated in FIG. 8. Indeed, any number of the bytes within the parallel control/data information (X′[63:0]) may be “control” bytes. Likewise, any number of the bytes within the parallel control/data information (X′[63:0]) may be “data” bytes. However, when all of the bytes within the parallel control/data information (X′[63:0]) are “data” bytes, good CDR transitions cannot be guaranteed, as described in detail below.

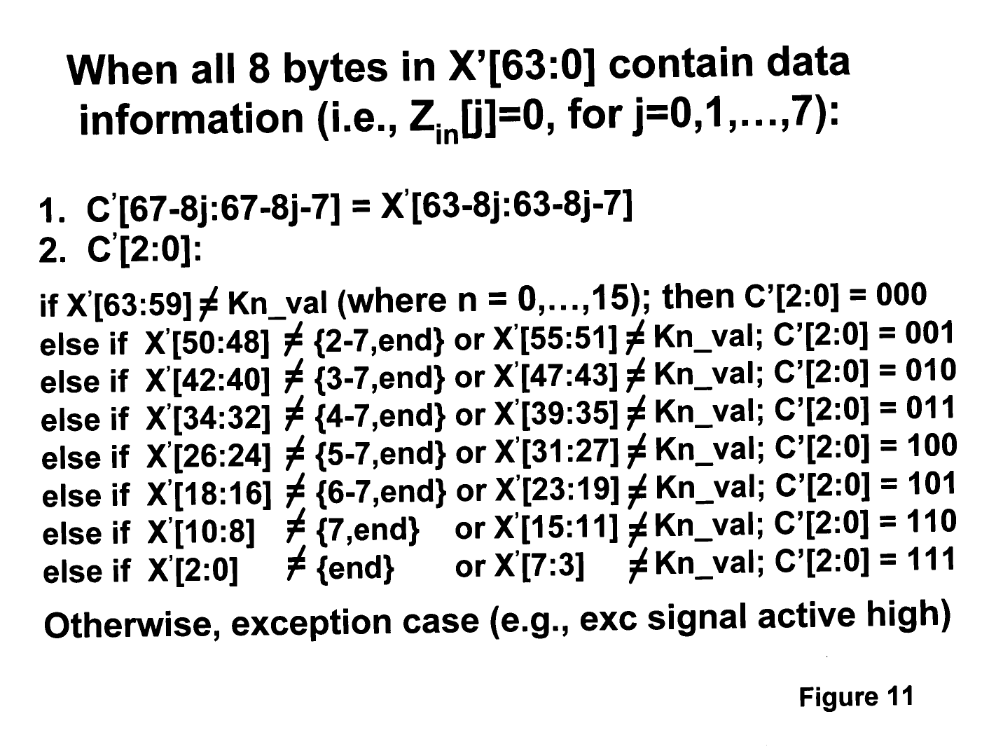

When all eight 8-bit bytes in the scrambled or unscrambled version of the parallel control/data information (X′[63:0]) contain data (D) information, the mapped parallel control/data information (C′[67:0]) is generated in accordance with the steps set forth in FIG. 11. In this case, the exception signal (exc) may be active if the mapped parallel control/data information (C′[67:0]) containing all data (D) information appears to contain all control (K) information, as described in detail below. Such an exception case is not a common occurrence (i.e., the probability of such an occurrence is less than 1%), and is easily accommodated in the DC balancer 604 with minimal effect on the 32s34s disparity bounding coding technique, as also described in detail below.

In accordance with the steps set forth in FIG. 11, if all of the bytes in the parallel control/data information (X′[63:0]) contain data (D) information, as indicated by the presence of a logic “0” in each of the bits of the parallel control/data indicator input information (Zᵢₙ[7:0]), then the upper 64 bits of the mapped parallel control/data information (C′[67:4]) may be set to match the 64 bits of the parallel control/data information (X′[63:0]), and the lower 3 bits of the mapped parallel control/data information (C′[2:0]) may be set to a value that is determined by comparing selected bits of the parallel control/data information (X′[63:0]) to valid control pointer field values (Kn_pnt), such as those listed in Table 1 of FIG. 9, and to valid control value field values (Kn_val), such as those listed in Table 2 of FIG. 10, as described in detail below.

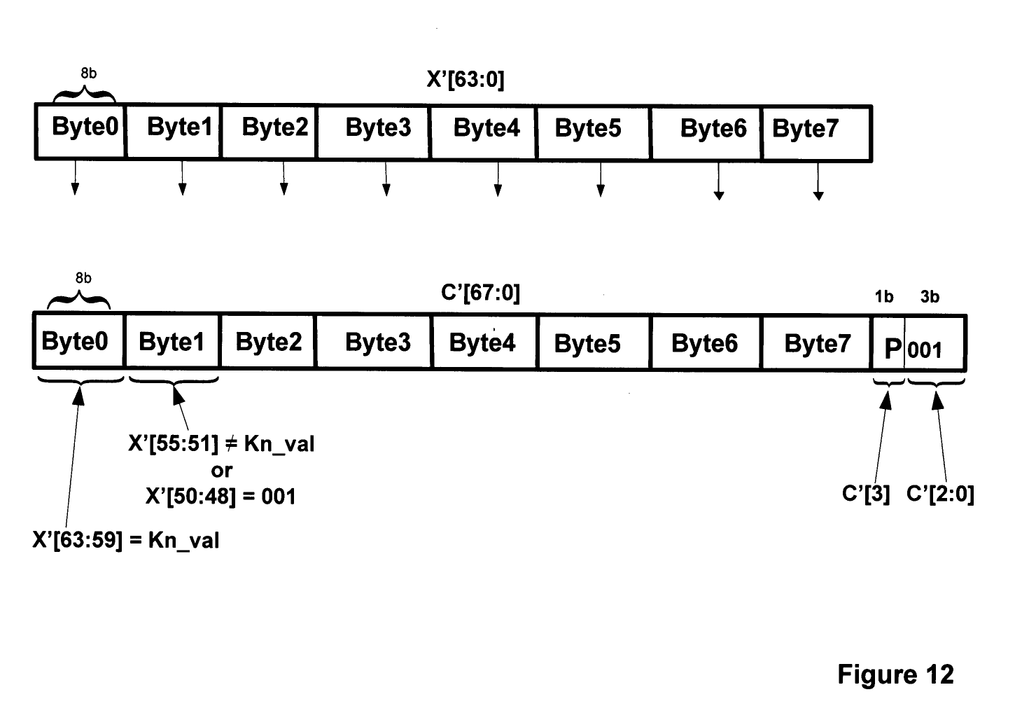

Referring to FIG. 12, there is shown an exemplary illustration of how the mapper 602 operates to generate the mapped parallel control/data information (C′[67:0]) when all eight 8-bit bytes in the scrambled or unscrambled version of the parallel control/data information (X′[63:0]) contain data (D) information. That is, FIG. 12 shows a representation of the scrambled or unscrambled version of the parallel control/data information (X′[63:0]) organized into eight 8-bit bytes. FIG. 12 also shows a representation of the mapped parallel control/data information (C′[67:0]), which includes the eight 8-bit bytes of the parallel control/data information (X′[63:0]), as well as four additional code bits for use in implementing a 32s34s disparity bounding coding technique in accordance with an embodiment of the present disclosure. As shown in FIG. 12, three (C′[2:0]) of the four additional code bits in the mapped parallel control/data information (C′[67:0]) may be used to indicate that all eight 8-bit bytes in the scrambled or unscrambled version of the parallel control/data information (X′[63:0]) contain data (D) information, while the remaining one (C′[3]) of the four additional code bits in the mapped parallel control/data information (C′[67:0]) may be used to provide a parity (P) bit for the mapped parallel control/data information (C′[67:0]).

After the upper 64 bits of the mapped parallel control/data information (C′[67:4]) are set to match the 64 bits of the parallel control/data information (X′[63:0]), and the lower 3 bits of the mapped parallel control/data information (C′[2:0]) are set to a value determined by comparing selected bits of the parallel control/data information (X′[63:0]) to valid control pointer field values (Kn_pnt) and valid control value field values (Kn_val), the 32s34s disparity bounding coding technique may continue as described in detail below.

At this point it should be noted that, regardless of whether the parallel control/data information (X′[63:0]) contains control (K) information or data (D) information, or both, the parity (P) bit (C′[3]) in the mapped parallel control/data information (C′[67:0]) may be chosen so that all mapped parallel control/data information (C′[67:0]) has the same parity, as described in detail below.

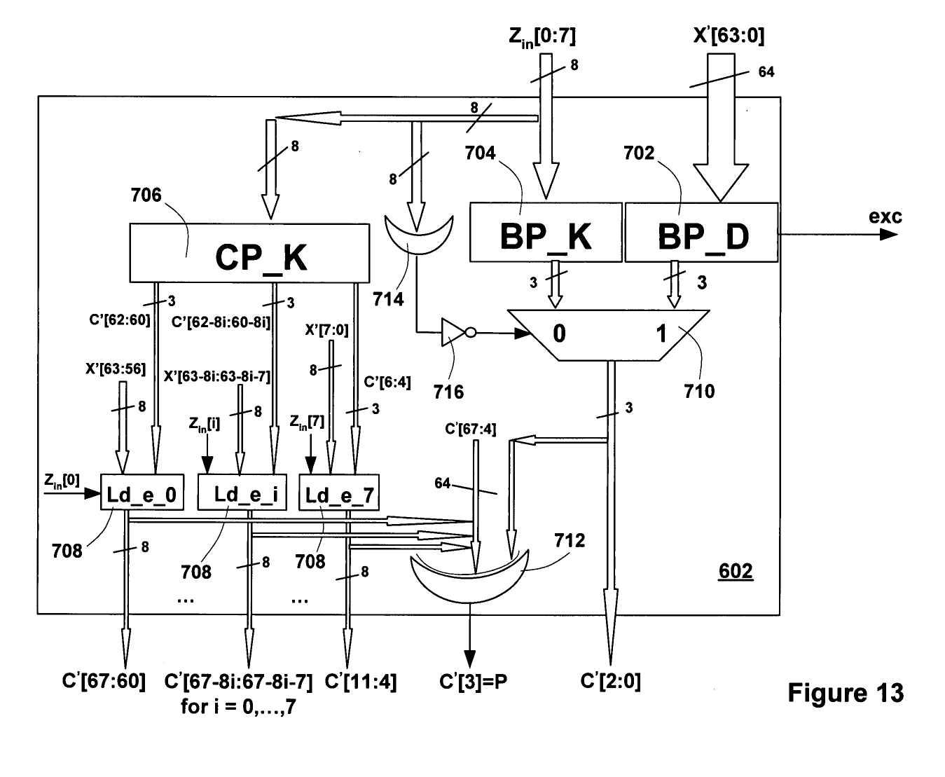

Referring to FIG. 13, there is shown an exemplary embodiment of the mapper 602 of FIG. 6. The mapper 602 comprises a data base pointer calculator 702, a control base pointer calculator 704, a control chain pointer calculator 706, a plurality of mapped parallel control/data information assemblers 708, multiplexer 710, an exclusive OR logic device 712, an OR logic device 714, and an inverter device 716. The data base pointer calculator 702 receives the parallel control/data information (X′[63:0]), and generates the lower 3 bits of the mapped parallel control/data information (C′[2:0]) based upon a value determined by comparing selected bits of the parallel control/data information (X′[63:0]) to valid control chain pointer field values (Kn_pnt) and valid control value field values (Kn_val), as described in detail below. The control base pointer calculator 704 receives the parallel control/data indicator input information (Zᵢₙ[7:0]), and generates a value (Kn_pnt) for the control base pointer field (C′[2:0]) based upon a position of a first “control” byte within the mapped parallel control/data information (C′[67:0]), as described in detail below. The control chain pointer calculator 706 receives the parallel control/data indicator input information (Zᵢₙ[7:0]), and generates control chain pointer field values (Kn_pnt) for the mapped parallel control/data information (C′[67:0]), as described in detail below. The plurality of mapped parallel control/data information assemblers 708 receive the parallel control/data information (X′[63:0]), control chain pointer field values (Kn_pnt) from the control chain pointer calculator 706, and the parallel control/data indicator input information (Zᵢₙ[7:0]), and generate the upper 64 bits of the mapped parallel control/data information (C′[67:4]), as described in detail below. The multiplexer 710 receives a select signal generated by the OR logic device 714 and the inverter device 716 based upon the parallel control/data indicator input information (Zᵢₙ[7:0]), and selects either the output from the data base pointer calculator 702 or the output from the control base pointer calculator 704 based thereon. The exclusive OR logic device 712 receives the upper 64 bits of the mapped parallel control/data information (C′[67:4]) and the output from the multiplexer 710, and generates the parity (P) bit (C′[3]) in the mapped parallel control/data information (C′[67:0]) based thereon.

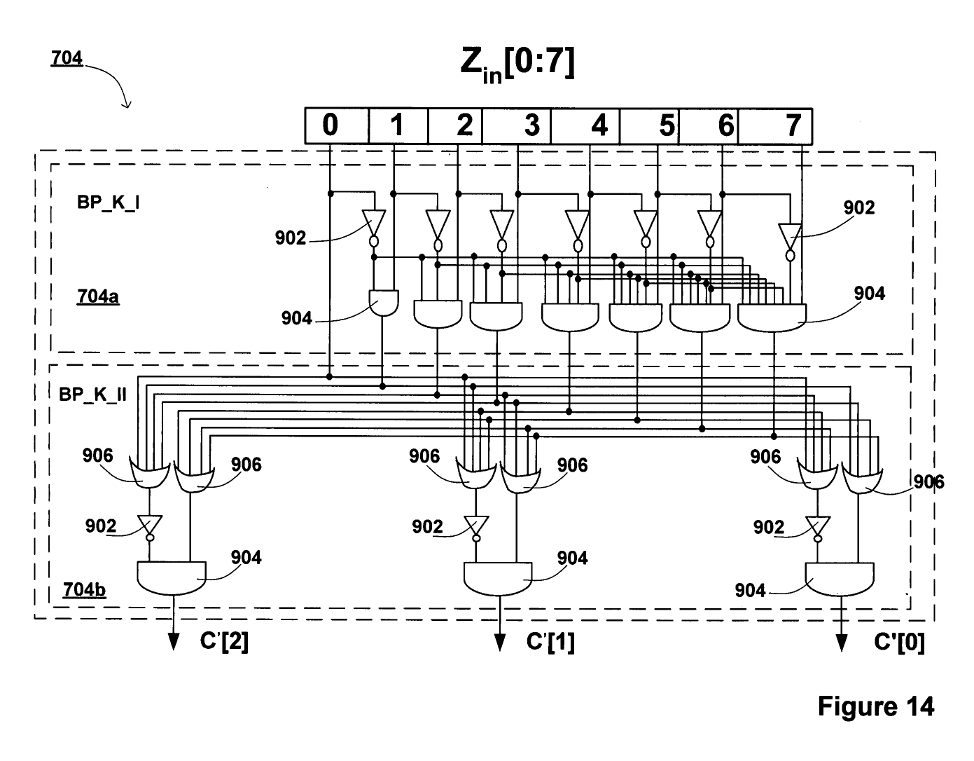

Referring to FIG. 14, there is shown an exemplary embodiment of the control base pointer calculator 704 of FIG. 13. The control base pointer calculator 704 comprises a plurality of inverter devices 902, a plurality of AND logic devices 904, and a plurality of OR logic devices 906. The control base pointer calculator 704 receives the parallel control/data indicator input information (Zᵢₙ[7:0]), and generates a value (Kn_pnt) for the control base pointer field (C′[2:0]) based upon a position of a first “control” byte within the mapped parallel control/data information (C′[67:0]) utilizing the plurality of inverter devices 902, the plurality of AND logic devices 904, and the plurality of OR logic devices 906. The control base pointer calculator 704 may be divided into two logic portions 704a and 704b, which may be used to describe other aspects of the mapper 602, as described in detail below.

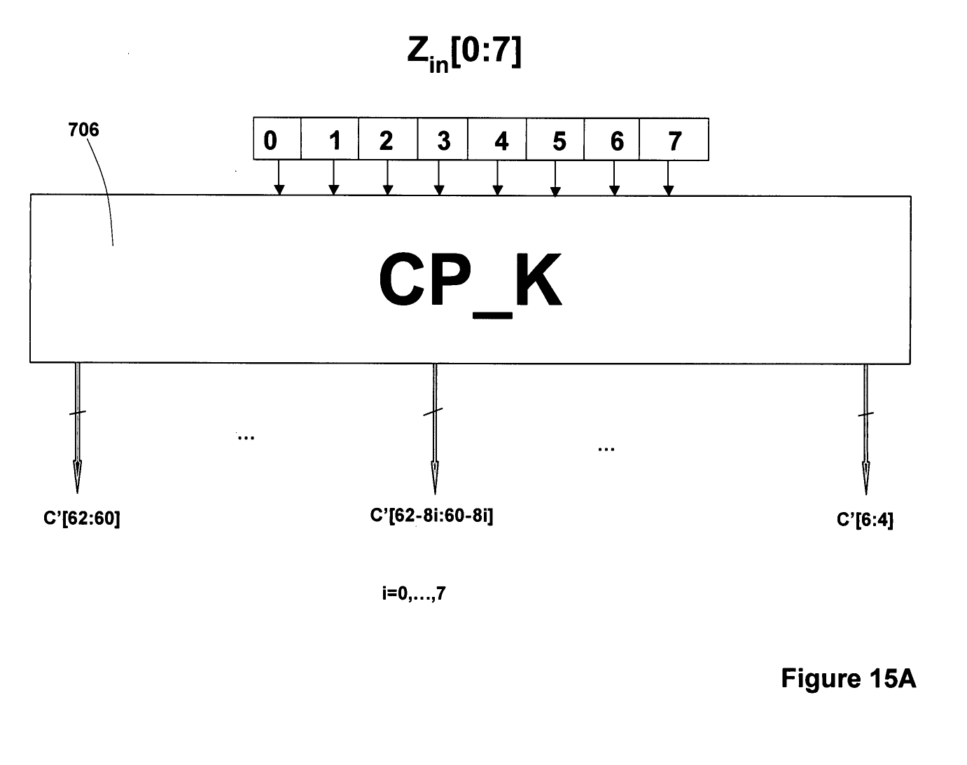

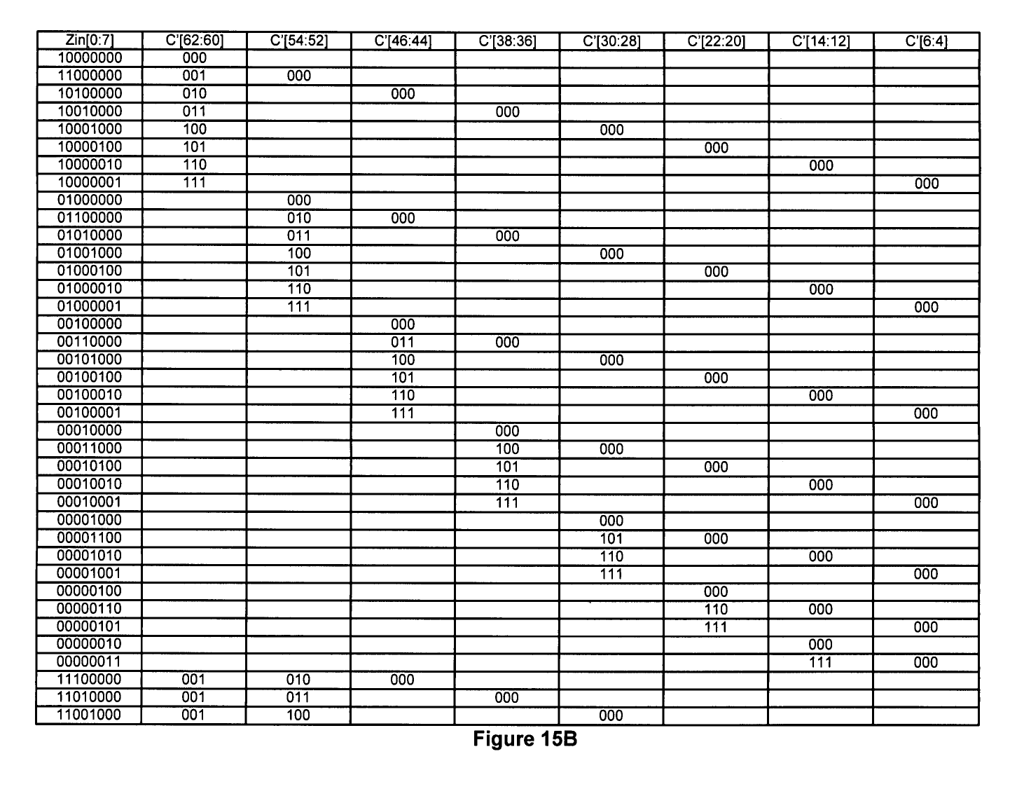

Referring to FIG. 15A, there is shown an exemplary embodiment of the control chain pointer calculator 706 of FIG. 13. The control chain pointer calculator 706 receives the parallel control/data indicator input information (Zᵢₙ[7:0]), and generates control chain pointer field values (Kn_pnt) for use in control chain pointer fields (Kn_pnt) in the mapped parallel control/data information (C′[67:0]) utilizing valid control chain pointer field values (Kn_pnt) such as those listed in Table 1 of FIG. 9.

Referring to FIG. 15B, there is shown an exemplary mapping table for the control chain pointer calculator 706 of FIG. 15A in accordance with an embodiment of the present disclosure. The mapping table of FIG. 15A illustrates how the control chain pointer calculator 706 of FIG. 15A generates control chain pointer field values (Kn_pnt) based upon received parallel control/data indicator input information (Zᵢₙ[0:7]). More particularly, Zᵢₙ[0] determines C′[62:60], Zᵢₙ[1] determines C′[54:52], . . . , and Zᵢₙ[7] determines C′[6:4], as set forth in FIG. 7. In summary, if Zᵢₙ[i]=1 for only one i out of i=0, . . . 7, then C′[62-8i:60-8i]=000. If Zᵢₙ[i]=1 and Zᵢₙ[j]=1, wherein i and j takes values from [0, 1, . . . 7] and i<j, then C′[62-8i:60-8i]=j (decimal) and C′[62-8j:60-8j]=000. If Zᵢₙ[i]=1, Zᵢₙ[j]=1, and Zᵢₙ[k]=1, wherein i, j, and k takes values from [0, 1, . . . 7] and i<j<k, then C′[62-8i:60-8i]=j (decimal), C′[62-8j:60-8j]=k (decimal), and C′[62-8k:60-8k]=000, etc.

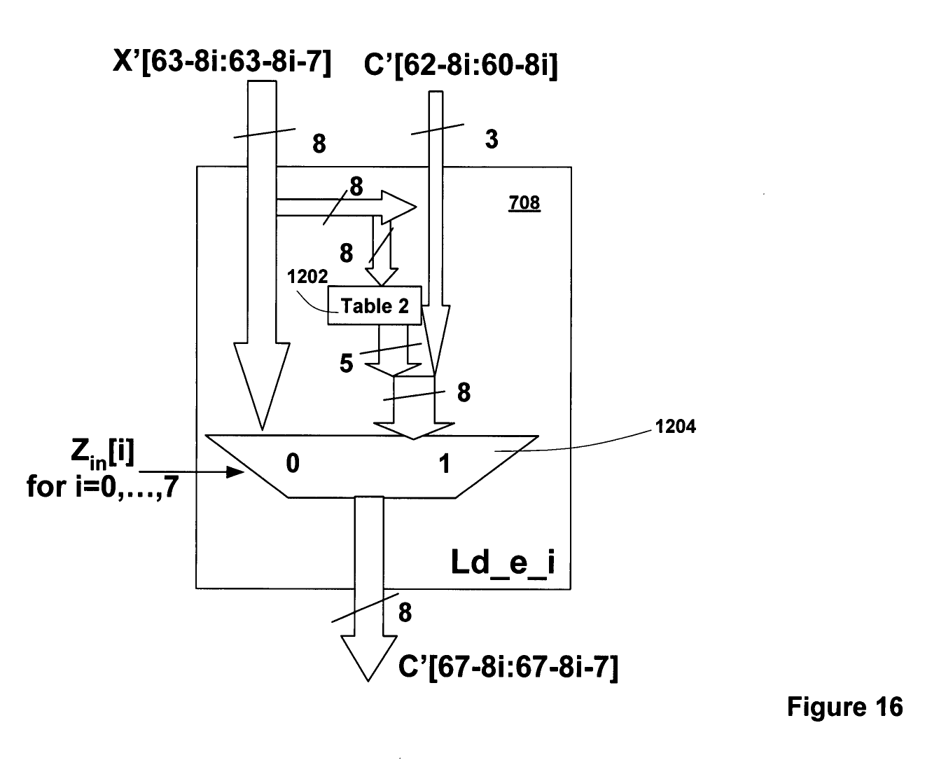

Referring to FIG. 16, there is shown an exemplary embodiment of one of the plurality of mapped parallel control/data information assemblers 708 of FIG. 13. The mapped parallel control/data information assembler 708 shown in FIG. 16 comprises look-up table logic 1202 and a multiplexer 1204. The look-up table logic 1202 receives a portion (i.e., 8-bit byte) of the parallel control/data information (X′[63:0]), and generates valid control value field values (Kn_val), such as those listed in Table 2 of FIG. 10. The multiplexer 1204 receives the parallel control/data indicator input information (Zᵢₙ[7:0]), each bit of which is used as a select signal to select between a respective portion of the parallel control/data information (X′[63:0]) and a bit combination comprised of a respective 3-bit control chain pointer field value (Kn_pnt) output from the control chain pointer calculator 706 and a respective 5-bit valid control value field value (Kn_val) output from the look-up table logic 1202.

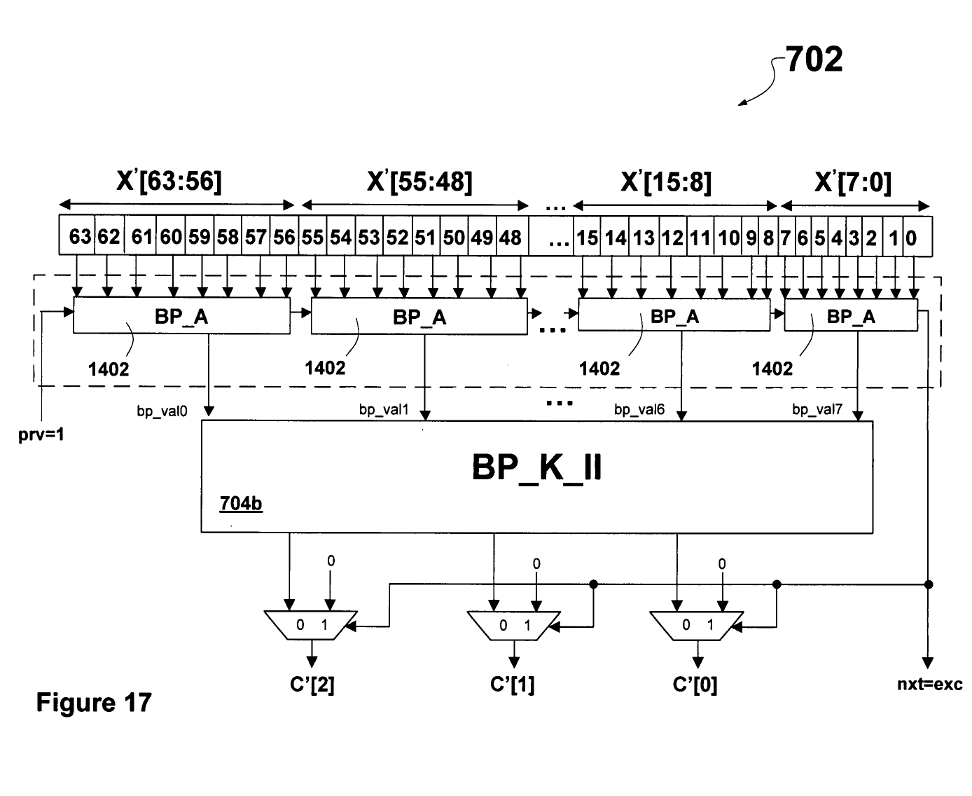

Referring to FIG. 17, there is shown an exemplary embodiment of the data base pointer calculator 702 of FIG. 13. The data base pointer calculator 702 comprises a plurality of data base pointer assignors 1402, as well as a logic portion 704b of the control base pointer calculator 704, as described above in FIG. 14. Each of the plurality of data base pointer assignors 1402 receives a respective portion (i.e., byte) of the parallel control/data information (X′[63:0]), and, in conjunction with the logic portion 704b of the control base pointer calculator 704, generates the lower 3 bits of the mapped parallel control/data information (C′[2:0]), as well as the exception (exc) signal, as described in detail below. When the exception (exc) signal is at a logic “1” state, C′[2:0]=000.

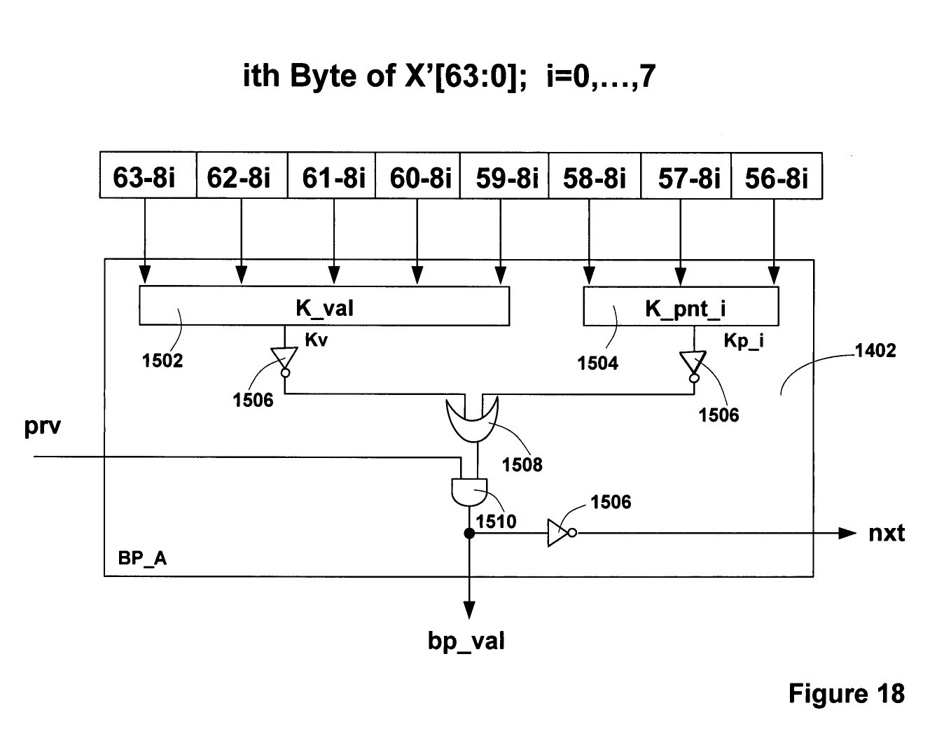

Referring to FIG. 18, there is shown an exemplary embodiment of one of the plurality of data base pointer assignors 1402 of FIG. 17. The data base pointer assignor 1402 shown in FIG. 18 comprises a control value comparator 1502, a control chain pointer comparator 1504, a plurality of inverter devices 1506, and OR logic device 1508, and an AND logic device 1510. The control value comparator 1502 receives selected bits of the parallel control/data information (X′[63:0]), and compares them to valid control value field values (Kn_val), as described in detail below. The control chain pointer comparator 1504 receives selected bits of the parallel control/data information (X′[63:0]), and compares them to valid control chain pointer field values (Kn_pnt), as described in detail below. The outputs from the control value comparator 1502 (i.e., Kv) and the control chain pointer comparator 1504 (i.e., Kp_i) are inverted by respective ones of the plurality of inverter devices 1506, and logically OR'ed utilizing the OR logic device 1508. The output from the OR logic device 1508 is logically AND'ed with a previous (prv) signal utilizing the AND logic device 1510. The output from the AND logic device 1510 provides a data base pointer value bit (bp_val) for use by the logic portion 704b of the control base pointer calculator 704. The output from the AND logic device 1510 is also inverted by a respective one of the plurality of inverter devices 1506 to provide a next (nxt) signal.

At this point it should be noted that the previous (prv) signal may be set to logic “1” for a first of the plurality of data base pointer assignors 1402, and the next (nxt) signal provides the exception (exc) signal for a last of the plurality of data base pointer assignors 1402, as shown in FIG. 17. However, in all other cases the previous (prv) signal received by a downstream data base pointer assignor 1402 represents the next (nxt) output from an upstream data base pointer assignor 1402, as shown in FIG. 17.

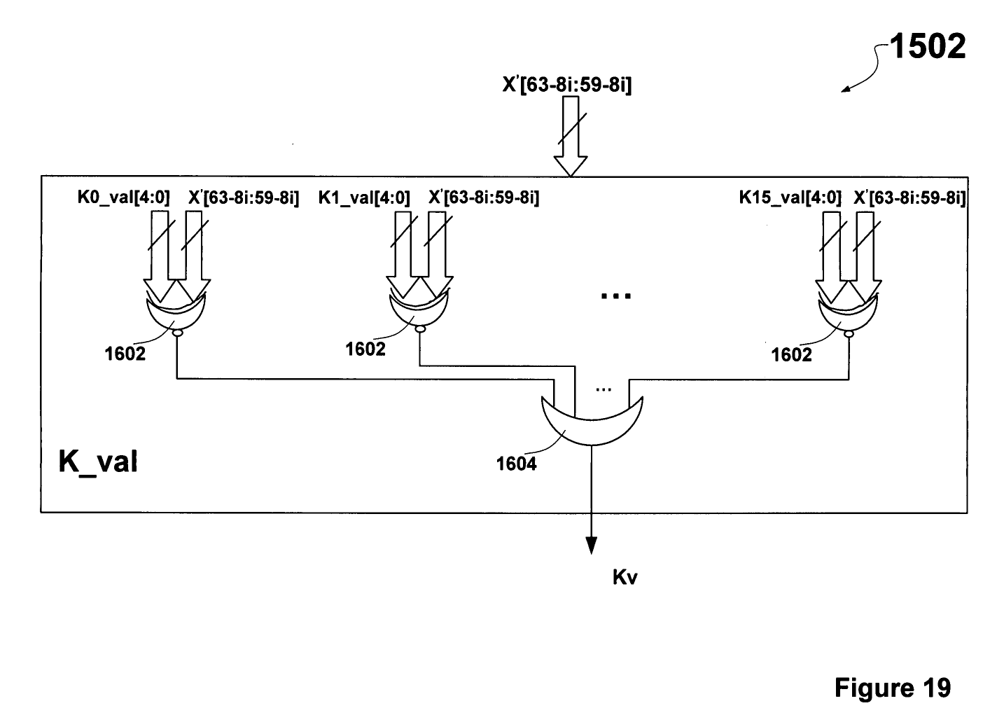

Referring to FIG. 19, there is shown an exemplary embodiment of the control value comparator 1502 of FIG. 18. The control value comparator 1502 comprises a plurality of exclusive NOR logic devices 1602 and an OR logic device 1604. Each of the plurality of exclusive NOR logic devices 1602 receives respective selected bits of the parallel control/data information (X′[63:0]), and compares them to valid control value field values (Kn_val). The outputs from each of the plurality of exclusive NOR logic devices 1602 are logically OR'ed utilizing the OR logic device 1604 to generate the output (i.e., Kv) from the control value comparator 1502.

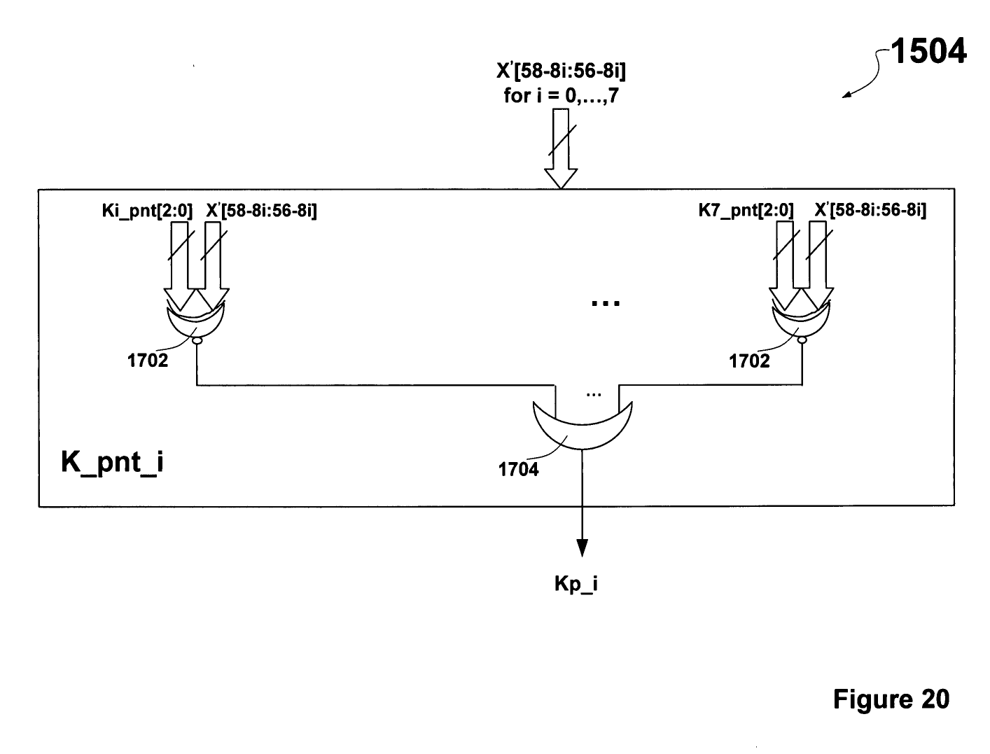

Referring to FIG. 20, there is shown an exemplary embodiment of the control chain pointer comparator 1504 of FIG. 18. The control chain pointer comparator 1504 comprises a plurality of exclusive NOR logic devices 1702 and an OR logic device 1704. Each of the plurality of exclusive NOR logic devices 1702 receives respective selected bits of the parallel control/data information (X′[63:0]), and compares them to valid control chain pointer field values (Kn_pnt). The outputs from each of the plurality of exclusive NOR logic devices 1702 are logically OR'ed utilizing the OR logic device 1704 to generate the output (i.e., Kp_i) from the control value comparator 1504.

Referring again to FIG. 6, the DC balancer 604 receives the mapped parallel control/data information (C′[67:0]) and the exception signal (exc) from the mapper 602, and generates 68-bit codewords (i.e., C[67:0]=(C₆₇, C₆₆, C₆₅, . . . C₀) for the serializing 4-PAM transmitter 404 that are organized as MSB codewords (M[33:0]) and LSB codewords (L[33:0]), as described above. The DC balancer 604 operates to generate the 68-bit codewords (i.e., C[67:0]=(C₆₇, C₆₆, C₆₅, . . . C₀) based primarily upon a comparison of a current weight polarity of the mapped parallel control/data information (C′[67:0]) and an accumulated weight polarity of previously encoded parallel control/data information (C[67:0]). That is, in accordance with the 32s34s disparity bounding coding technique, after the mapped parallel control/data information (C′[67:0]) has been generated, a current weight polarity of the mapped parallel control/data information (C′[67:0]) may be calculated and compared to an accumulated weight polarity of previously encoded parallel control/data information (C[67:0]).

If the current weight polarity of the mapped parallel control/data information (C′[67:0]) is the same as the accumulated weight polarity of the previously encoded parallel control/data information (C[67:0]), then the current weight polarity of the mapped parallel control/data information (C′[67:0]) may be reversed to provide current encoded parallel control/data information (C[67:0]), thereby providing a DC balancing property in accordance with the 32s34s disparity bounding coding technique. Such a reversal of the current weight polarity of the mapped parallel control/data information (C′[67:0]) may comprise changing the logic state of all of the symbol MSB's (i.e., mapped MSB codeword (M′[33:0]) having 34 codeword bits organized as [C₆₆, C₆₄, C₆₂, . . . C₀]) within the mapped parallel control/data information (C′[67:0]), as well as the parity (P) bit (C′[3]).

Of course, such a reversal of the current weight polarity of the mapped parallel control/data information (C′[67:0]) may result in a parity difference between the mapped parallel control/data information (C′[67:0]) and the encoded parallel control/data information (C[67:0]). This parity difference may be detected by the decoder 408 of FIG. 4, which may then use this information to decode the encoded parallel control/data information (C[67:0]) into parallel control/data output information (Xₒᵤₜ[63:0]) and parallel control/data indicator output information (Zₒᵤₜ[7:0]) resembling the parallel control/data input information (Xᵢₙ[63:0]) and the parallel control/data indicator input information (Zᵢₙ[7:0]), respectively, as described in detail below.

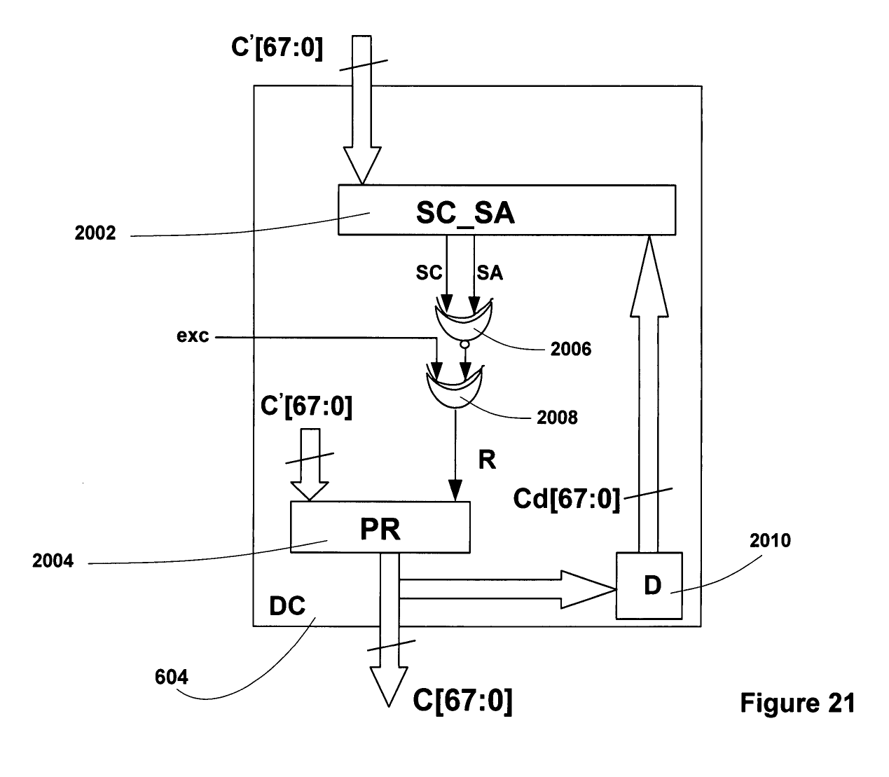

Referring to FIG. 21, there is shown an exemplary embodiment of the DC balancer 604 of FIG. 6. The DC balancer 604 comprises a current/accumulated weight polarity sign generator 2002, a polarity reversal circuit 2004, an exclusive NOR logic device 2006, an exclusive OR logic device 2008, and a delay element 2010. The current/accumulated weight polarity sign generator 2002 receives both the mapped parallel control/data information (C′[67:0]) and delayed encoded parallel control/data information (C[67:0]), and generates a signal (i.e., the SC signal) representing the sign of the current weight polarity of the current mapped parallel control/data information (C′[67:0]) and a signal representing the sign (i.e., the SA signal) of the accumulated weight polarity of previously encoded parallel control/data information (C[67:0]), as described in detail below. The exclusive NOR logic device 2006 logically exclusively NOR's the SC signal and the SA signal. The exclusive OR logic device 2008 logically exclusively OR's the output from exclusive NOR logic device 2006 and the exception signal (exc) from the mapper 602 to generate a reversal (R) signal. The polarity reversal circuit 2004 receives the current mapped parallel control/data information (C′[67:0]) and the reversal (R) signal, and generates encoded parallel control/data information (C[67:0]), as described in detail below. The delay element 2010 delays the encoded parallel control/data information (C[67:0]), preferably for 68 bit periods (i.e., 1 codeword period), and generates the delayed encoded parallel control/data information (Cd[67:0]).

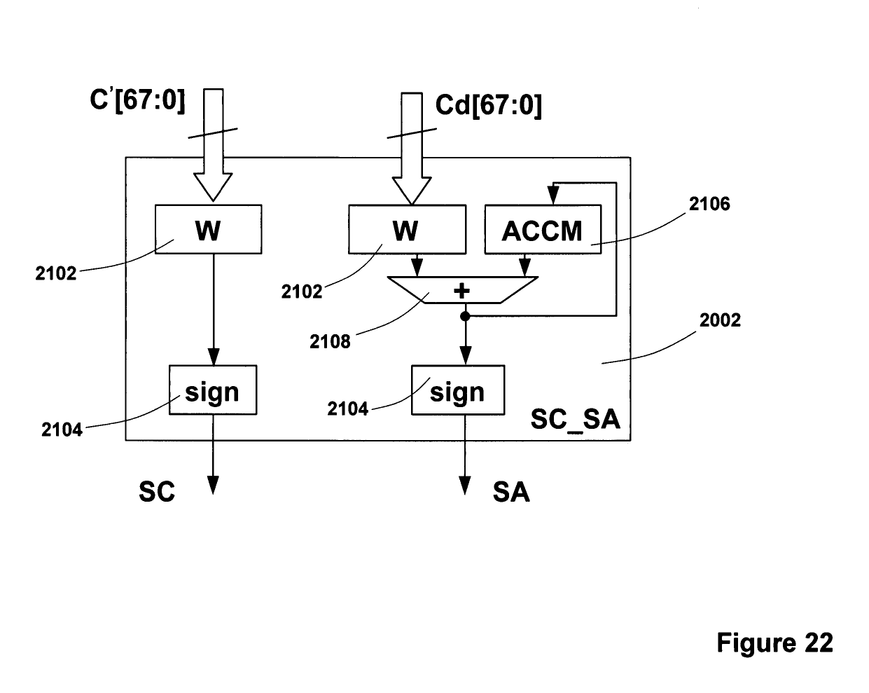

Referring to FIG. 22, there is shown an exemplary embodiment of the current/accumulated weight polarity sign generator 2002 of FIG. 21. The current/accumulated weight polarity sign generator 2002 comprises a pair of polarity weight calculators 2102, a pair of weight polarity sign generators 2104, a polarity weight accumulator 2106, and an adder 2108. A first of the pair of polarity weight calculators 2102 receives the current mapped parallel control/data information (C′[67:0]), and a second of the pair of polarity weight calculators 2102 receives previously encoded parallel control/data information (C[67:0]). A first of the pair weight polarity sign generators 2104 receives the output from the first of the pair of polarity weight calculators 2102, and generates the SC signal. The polarity weight accumulator 2106 receives an output from the adder 2108, and provides an output to the adder 2108. The adder 2108 receives the output from the second of the pair of polarity weight calculators 2102 and the output from the polarity weight accumulator 2106, and then adds these two outputs. The second of the pair weight polarity sign generators 2104 receives the output from the adder 2108, and generates the SA signal.

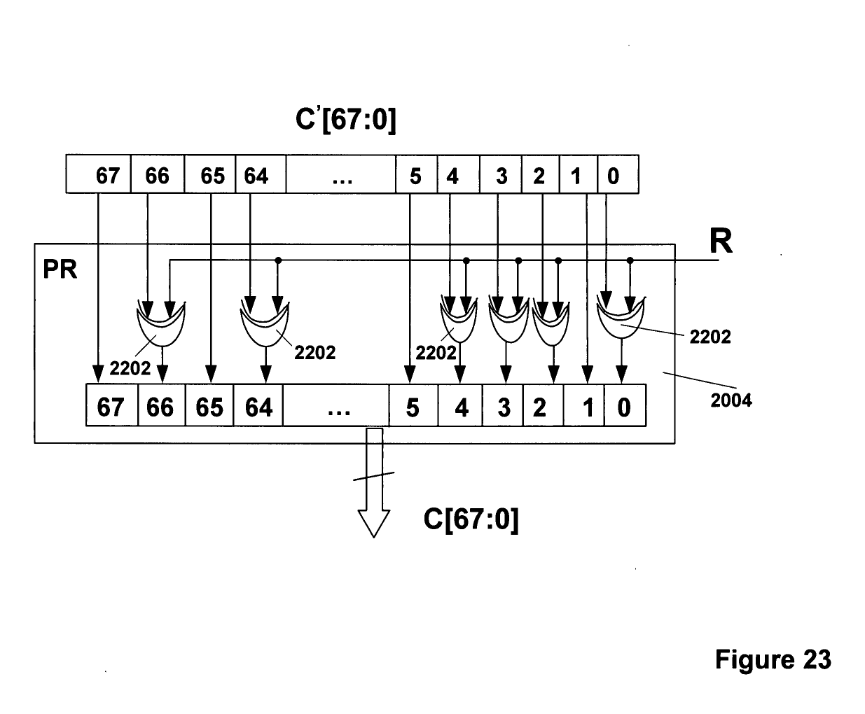

Referring to FIG. 23, there is shown an exemplary embodiment of the polarity reversal circuit 2004 of FIG. 21. The polarity reversal circuit 2004 comprises a plurality of exclusive OR logic devices 2202. Each of the plurality of exclusive OR logic devices 2202 receive the reversal (R) signal and a respective bit (i.e., one of C′[66], C′[64], . . . , and C′[0]) of the current mapped parallel control/data information (C′[67:0]), and generate a respective bit of the encoded parallel control/data information (C[67:0]). Other bits of the encoded parallel control/data information (C[67:0]) are generated directly from respective bits the current mapped parallel control/data information (C′[67:0]).

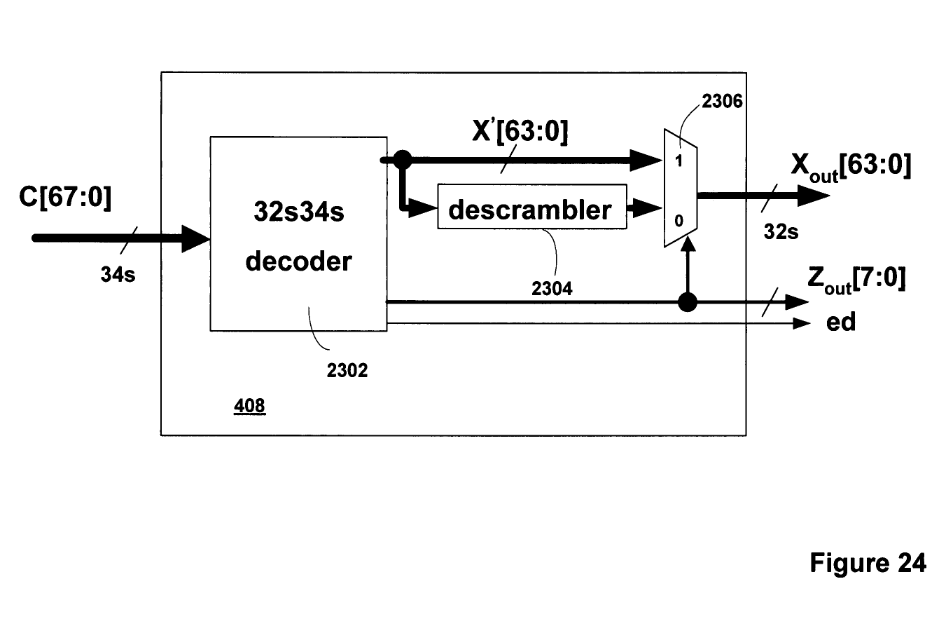

Referring to FIG. 24, there is shown an exemplary embodiment of the decoder 408 of FIG. 4. The decoder 408 comprises a 32s34s decoder 2302, a descrambler 2304, and a multiplexer 2306. Assuming that the 4-PAM signaling system 400 shown in FIG. 4 is utilizing a 32s34s disparity bounding coding technique in accordance with an embodiment of the present disclosure, the 32s34s decoder 2302 receives the encoded parallel control/data information (C[67:0]), and operates to decode the encoded parallel control/data information (C[67:0]) in accordance with the 32s34s disparity bounding coding technique. The 32s34s decoder 2302 provides decoded parallel control/data information (X′[63:0]) to both the descrambler 2304 and the multiplexer 2306. The decoded parallel control/data information (X′[63:0]) represents either a totally or partially scrambled or an unscrambled version of the parallel control/data input information (Xᵢₙ[63:0]). The 32s34s decoder 2302 also provides the parallel control/data indicator output information (Zₒᵤₜ[7:0]) to the multiplexer 2306, which indicates whether a respective byte of the decoded parallel control/data information (X′[63:0]) is comprised of control (K) information or data (D) information, as described above. The 32s34s decoder 2302 further provides an error output information signal (ed), which indicates whether any errors have been detected in the parallel control/data output information (Xₒᵤₜ[63:0]), as described in more detail below.

If the parallel control/data input information (Xᵢₙ[63:0]) was neither totally nor partially scrambled by the scrambler 502 in the encoder 402 (e.g., if the parallel control/data input information (Xᵢₙ[63: 0] ) was carrying only control information) then the decoded parallel control/data information (X′[63:0]) represents an unscrambled version of the parallel control/data input information (Xᵢₙ[63:0]), and the decoded parallel control/data information (X′[63:0]) is passed through the multiplexer 2306 and output as the parallel control/data output information (Xₒᵤₜ[63:0]). However, if the parallel control/data input information (Xᵢₙ[63:0]) was either totally or partially scrambled by the encoder 402 (e.g., if the parallel control/data input information (Xᵢₙ[63:0]) was carrying at least some data information), then the decoded parallel control/data information (X′[63:0]) represents a totally or partially scrambled version of the parallel control/data input information (Xᵢₙ[63:0]), and any scrambled portions of the decoded parallel control/data information (X′[63:0]) are passed through the descrambler 2304, which operates to descramble the scrambled portions of the decoded parallel control/data information (X′[63:0]) that is passed therethrough, which is a common function in many code-based signaling systems. The descrambler 2304 then provides an unscrambled version of the scrambled portions of the decoded parallel control/data information (X′[63:0]) to the multiplexer 2306 for output as the parallel control/data output information (Xₒᵤₜ[63:0]). Meanwhile, any unscrambled portions of the decoded parallel control/data information (X′[63:0]) are passed directly through the multiplexer 2306 and output as the parallel control/data output information (Xₒᵤₜ[63:0]). As shown in FIG. 24, the multiplexer 2306 is controlled by bits of the parallel control/data indicator output information (Zₒᵤₜ[7:0]), which indicate whether respective bytes of the decoded parallel control/data information (X′[63:0]) comprise control (K) information or data (D) information.

At this point it should be noted that the descrambler 2304, and thus the multiplexer 2306, are entirely optional in the decoder 408. That is, the decoder 408 may simply comprise the 32s34s decoder 2302 for the 4-PAM signaling system 400 shown in FIG. 4 to operate utilizing a 32s34s disparity bounding coding technique in accordance with an embodiment of the present disclosure.

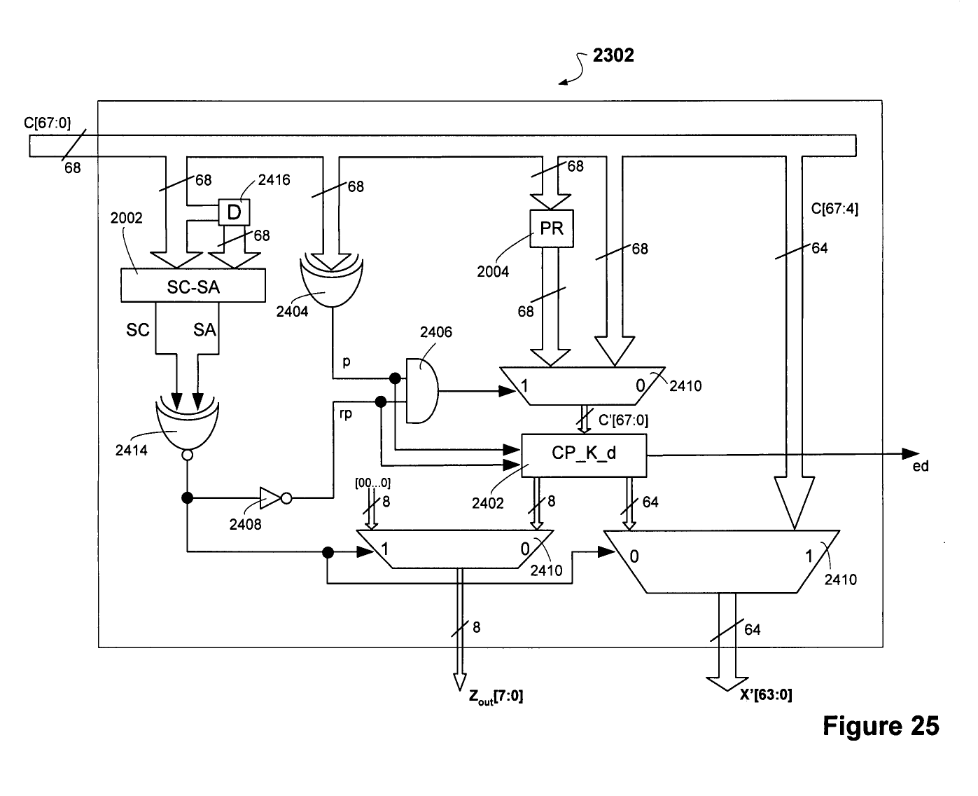

Referring to FIG. 25, there is shown an exemplary embodiment of the 32s34s decoder 2302 of FIG. 24. The 32s34s decoder 2302 comprises a current/accumulated weight polarity sign generator 2002 of FIG. 22, a polarity reversal circuit 2004 of FIG. 23, a control chain pointer decoder 2402, an exclusive OR logic device 2404, an AND logic device 2406, an inverter device 2408, a plurality of multiplexers 2410, an exclusive NOR logic device 2414, and a delay element 2416. The exclusive OR logic device 2404 outputs a parity (p) signal, while the inverter device 2408 outputs a relative polarity (rp) signal. Both of these signals are used by the control chain pointer decoder 2402, as described in more detail below.

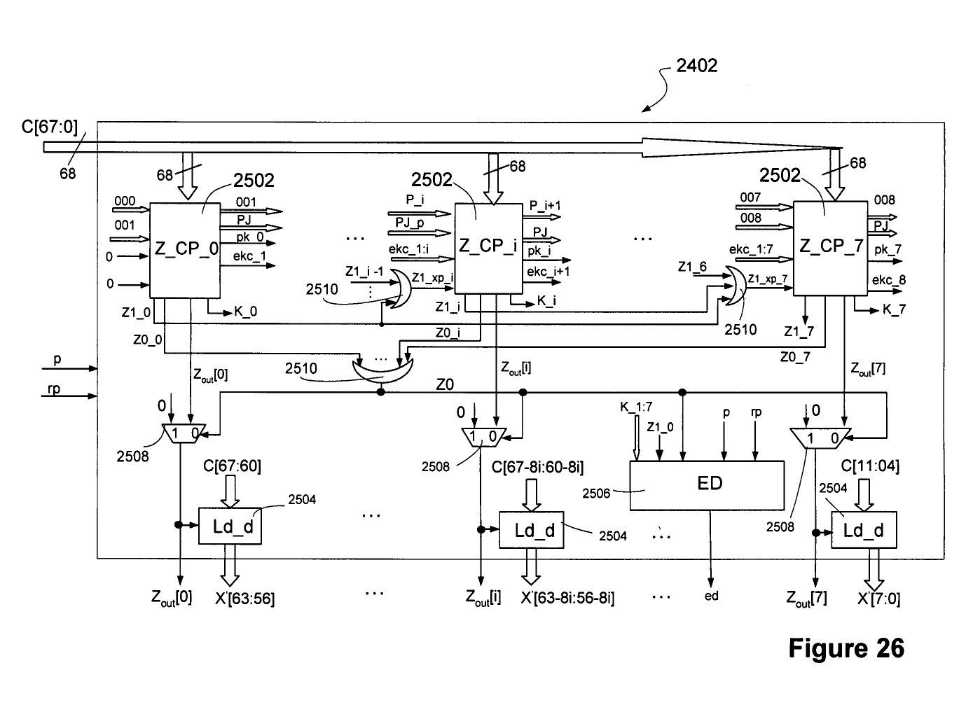

Referring to FIG. 26, there is shown an exemplary embodiment of the control chain pointer decoder 2402 of FIG. 25. The control chain pointer decoder 2402 shown in FIG. 26 comprises a plurality of control chain pointer decoder logic circuits 2502, a plurality of demapped parallel control/data information assemblers 2504, error detection logic 2506, a plurality of multiplexers 2508, and a plurality of OR logic devices 2510.

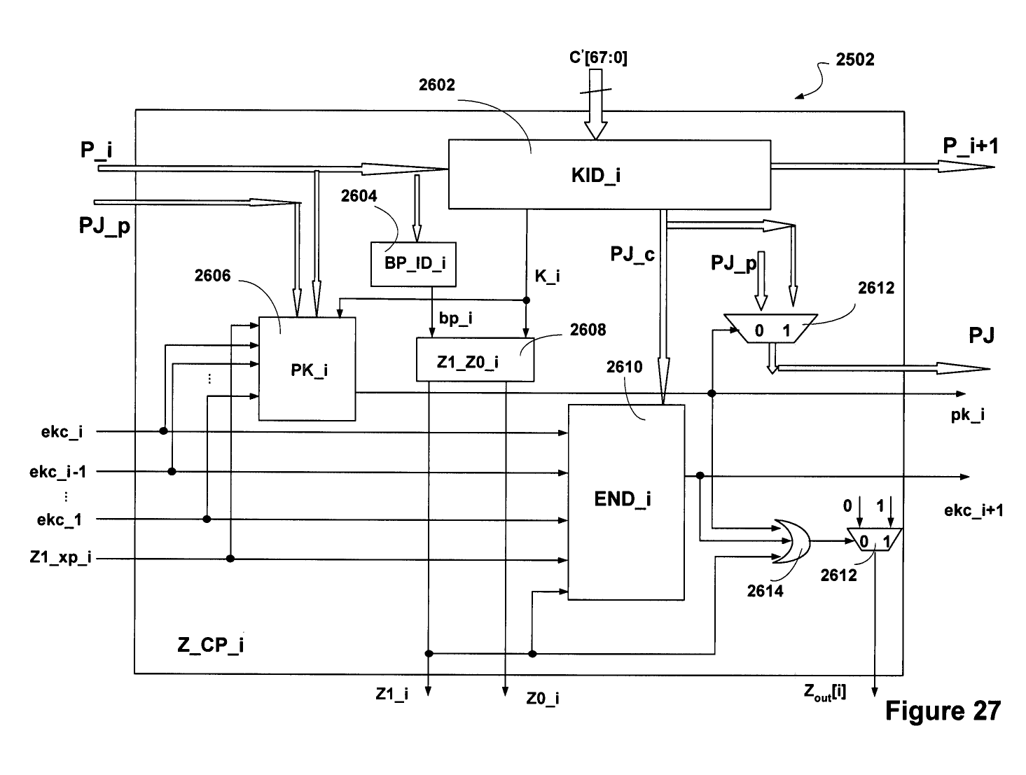

Referring to FIG. 27, there is shown an exemplary embodiment of one of the plurality of control chain pointer decoder logic circuits 2502 of FIG. 26. The control chain pointer decoder logic circuit 2502 shown in FIG. 27 comprises control validation logic 2602, control base pointer identification logic 2604, control chain pointer identification logic 2606, control base pointer validation logic 2608, control chain pointer end confirmation logic 2610, a pair of multiplexers 2612, and an OR logic device 2614.

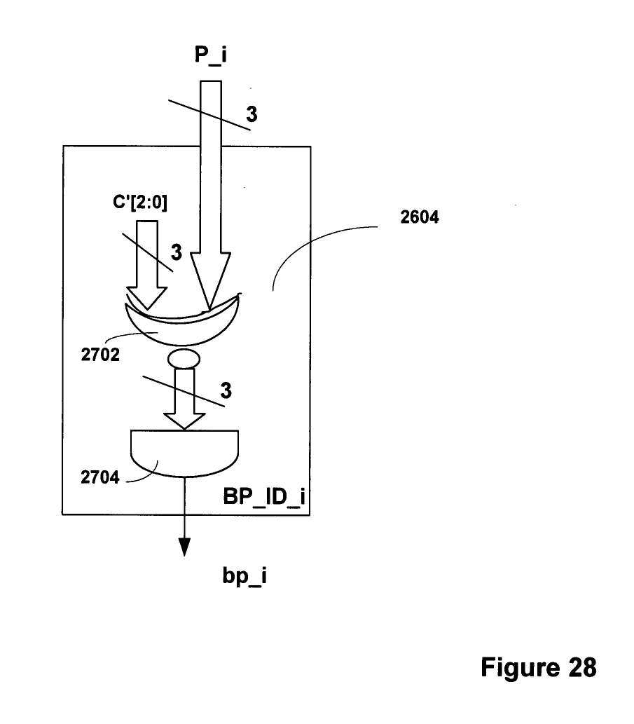

Referring to FIG. 28, there is shown an exemplary embodiment of the control base pointer identification logic 2604 of FIG. 27. The control base pointer identification logic 2604 comprises an exclusive NOR logic device 2702 and an AND logic device 2704.

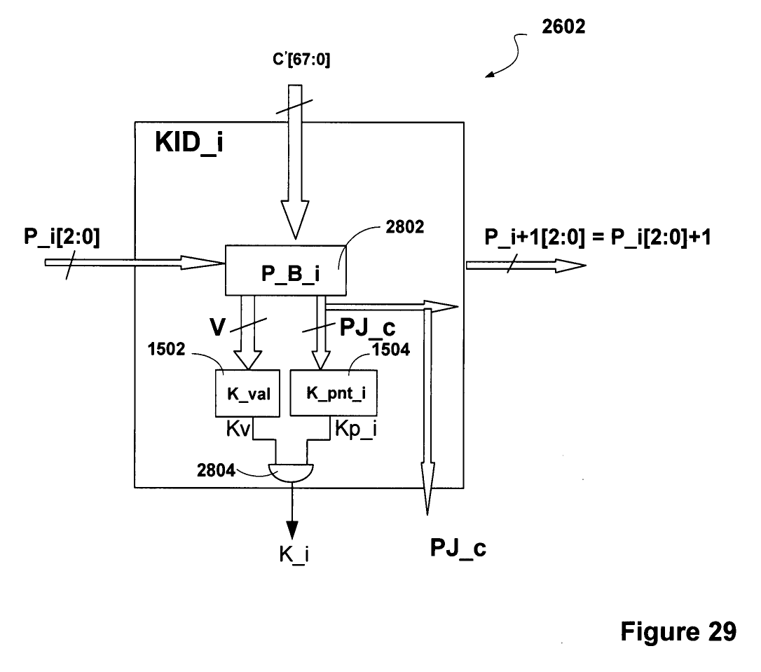

Referring to FIG. 29, there is shown an exemplary embodiment of the control validation logic 2602 of FIG. 27. The control validation logic 2602 comprises pointed byte logic 2802, a control value comparator 1502 of FIG. 19, a control chain pointer comparator 1504 of FIG. 20, and an AND logic device 2804.

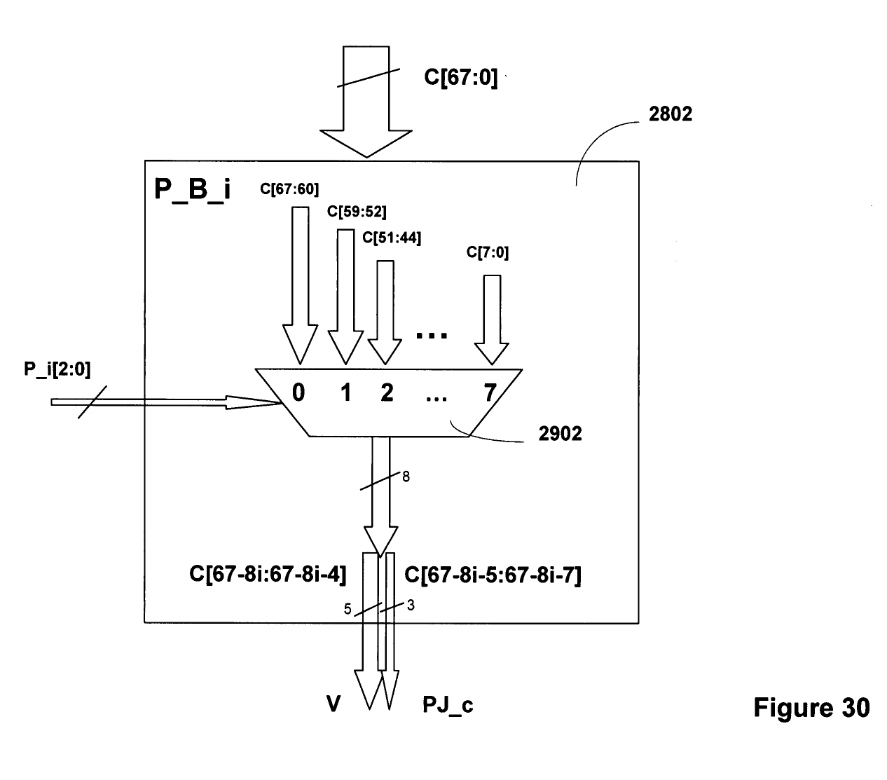

Referring to FIG. 30, there is shown an exemplary embodiment of the pointed byte logic 2802 of FIG. 29. The pointed byte logic 2802 comprises a multiplexer 2902.

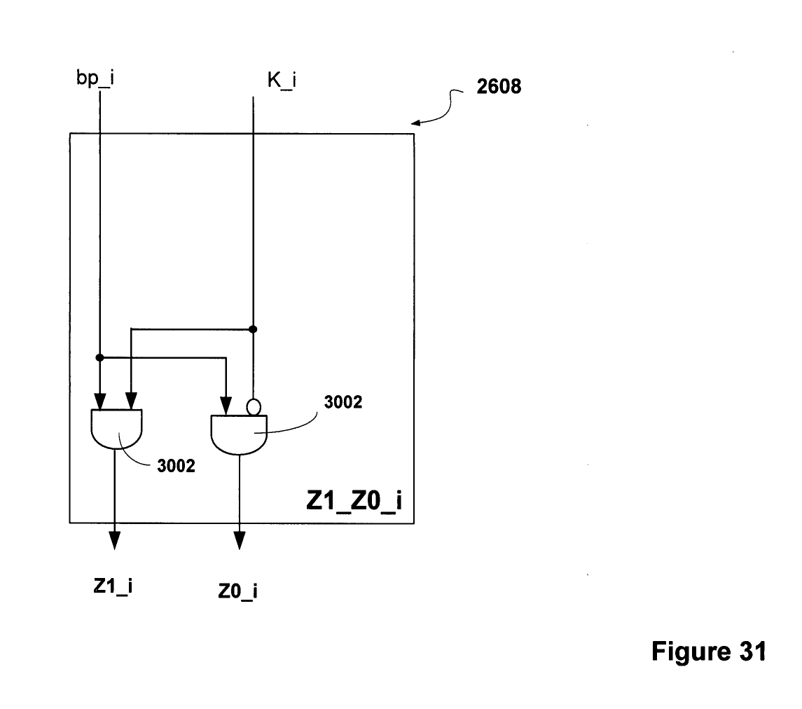

Referring to FIG. 31, there is shown an exemplary embodiment of the control base pointer validation logic 2608 of FIG. 27. The control base pointer validation logic 2608 comprises a plurality of AND logic devices 3002.

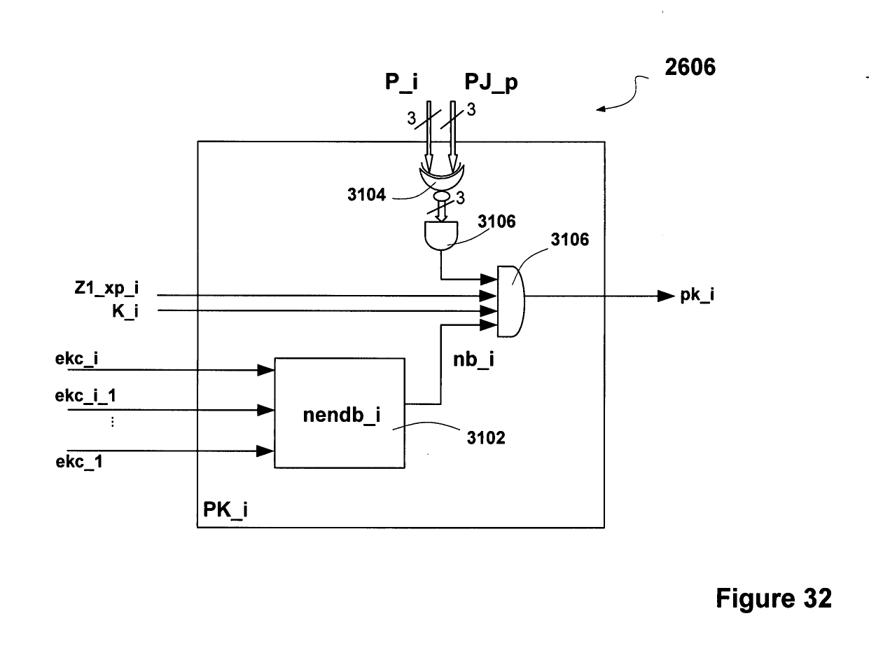

Referring to FIG. 32, there is shown an exemplary embodiment of the control chain pointer identification logic 2606 of FIG. 27. The control chain pointer identification logic 2606 comprises termination logic 3102, an exclusive NOR logic device 3104, and a pair of AND logic devices 3106.

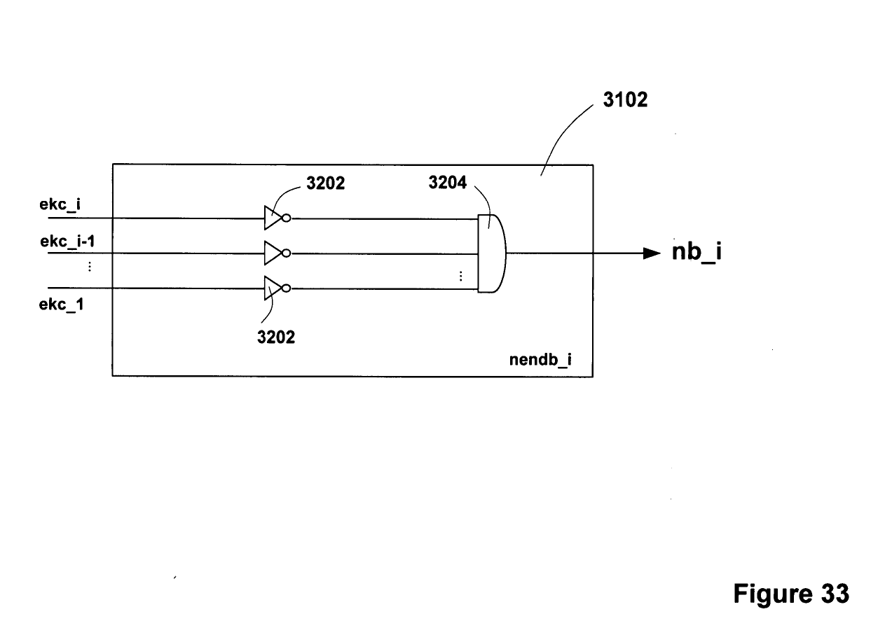

Referring to FIG. 33, there is shown an exemplary embodiment of the termination logic 3102 of FIG. 32. The termination logic 3102 comprises a plurality of inverter devices 3202 and an AND logic device 3204.

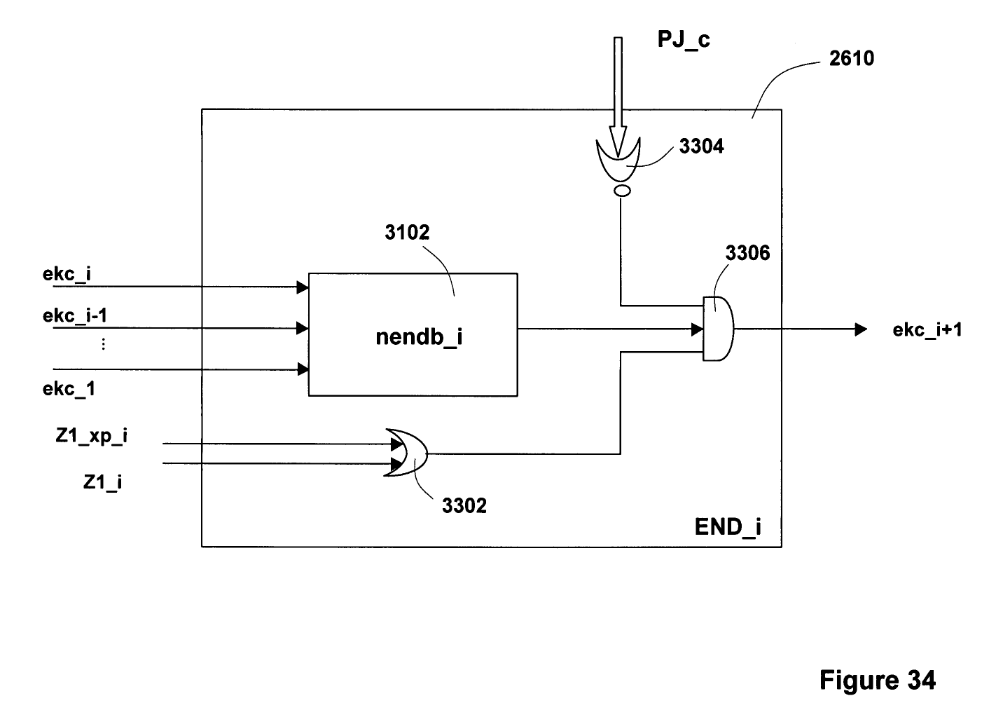

Referring to FIG. 34, there is shown an exemplary embodiment of the control chain pointer end confirmation logic 2610 of FIG. 27. The control chain pointer end confirmation logic 2610 comprises termination logic 3102 of FIG. 33, an OR logic device 3302, a NOR logic device 3304, and an AND logic device 3306.

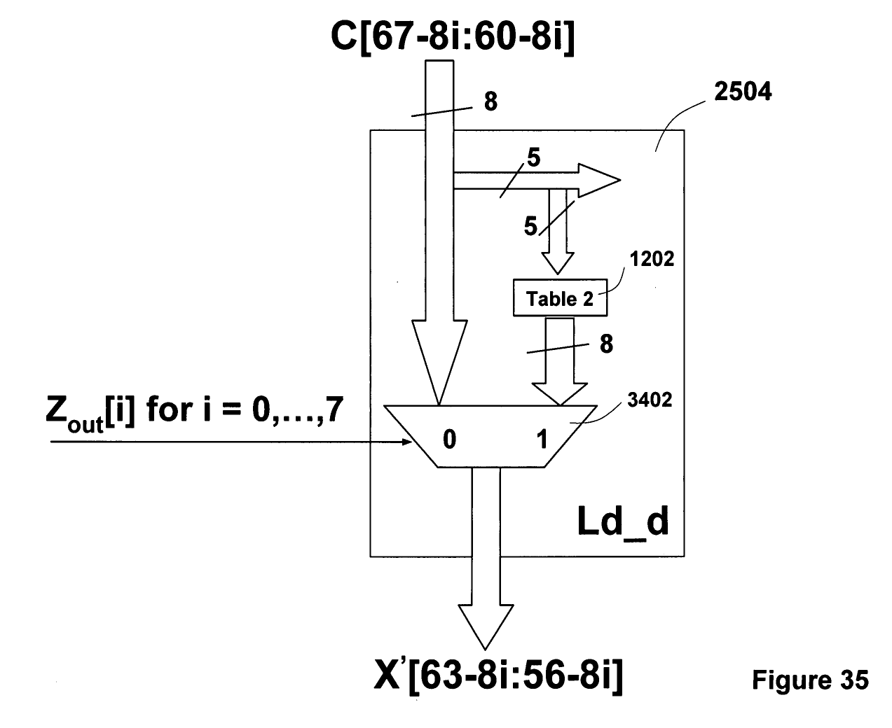

Referring to FIG. 35, there is shown an exemplary embodiment of one of the plurality of demapped parallel control/data information assemblers 2504 of FIG. 26. The demapped parallel control/data information assembler 2504 shown in FIG. 35 comprises look-up table logic 1202, similar to that of FIG. 16, and a multiplexer 3402.

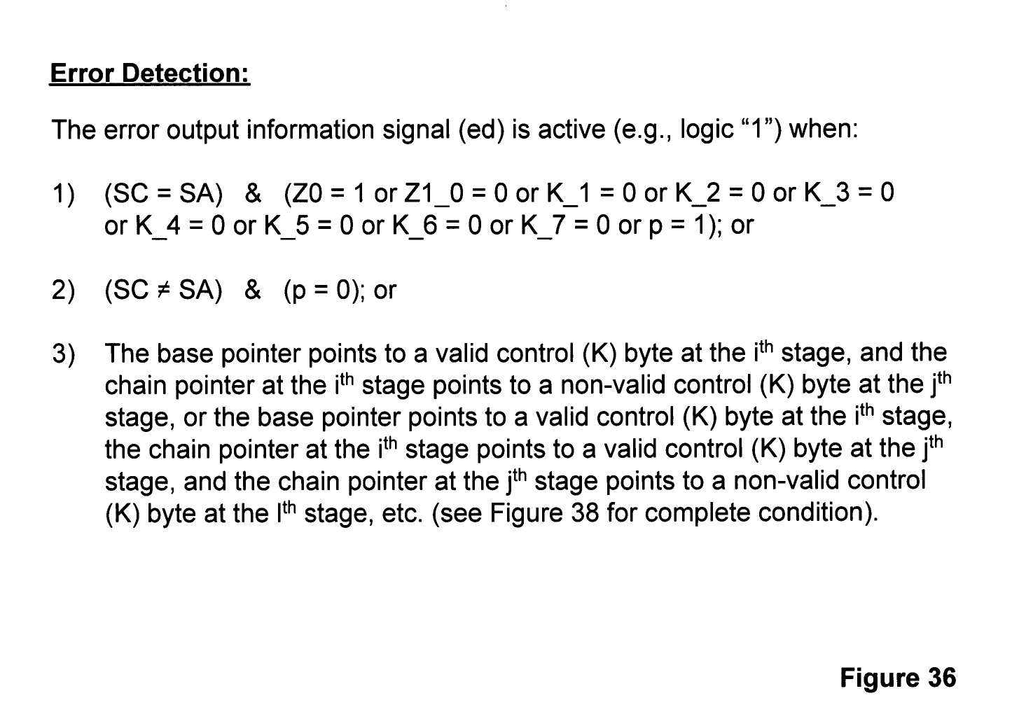

Referring to FIG. 36, there is shown a chart listing the conditions required for activating the error output information signal (ed) in accordance with an embodiment of the present disclosure. The error output information signal (ed) may be indicative of, for example, channel errors or loss of synchronization. When the error output information signal (ed) contains loss of synchronization information, the error output information signal (ed) may be used for framing purposes.

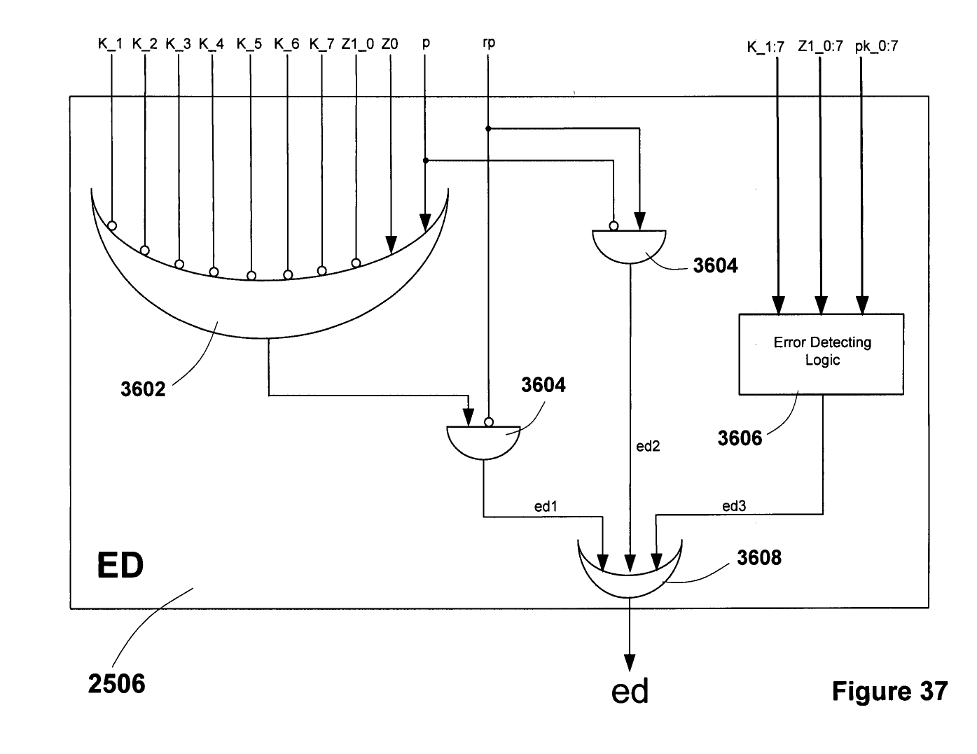

Referring to FIG. 37, there is shown an exemplary embodiment of the error detection logic 2506 of FIG. 26, which operates in accordance with the conditions set forth in the chart of FIG. 36. The error detection logic 2506 comprises a first OR logic device 3602, a pair of AND logic devices 3604, an error detected logic circuit 3606, and a second OR logic device 3608. A first of the pair of AND logic devices 3604 outputs a first error detected signal (ed1), a second of the pair of AND logic devices 3604 outputs a second error detected signal (ed2), and the error detected logic circuit 3606 outputs a third error detected signal (ed3). The second OR logic device 3608 logically OR's the outputs of the pair of AND logic devices 3604 and the error detected logic circuit 3606 to generate the error output information signal (ed).

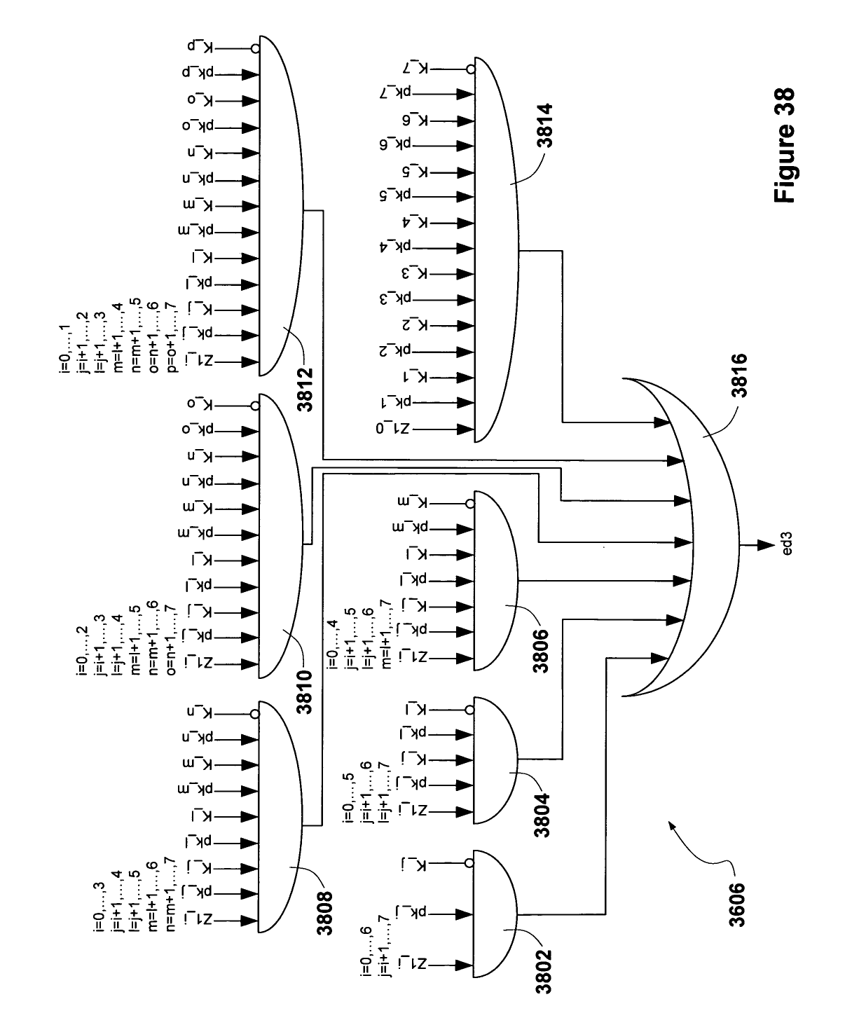

Referring to FIG. 38, there is shown an exemplary embodiment of the error detected logic circuit 3606 of FIG. 37. The error detected logic circuit 3606 comprises a first AND logic device 3802, a second AND logic device 3804, a third AND logic device 3806, a fourth AND logic device 3808, a fifth AND logic device 3810, a sixth AND logic device 3812, a seventh AND logic device 3814, and an OR logic device 3816. The output of the first AND logic device 3802 is active high if the base pointer points to a valid control (K) byte at the i^{th} stage, and the chain pointer at the i^{th} stage points to a non-valid control (K) byte at the j^{th} stage. The output of the second AND logic device 3804 is active high if the base pointer points to a valid control (K) byte at the i^{th} stage, the chain pointer at the i^{th} stage points to a valid control (K) byte at the j^{th} stage, and the chain pointer at the j^{th} stage points to a non-valid control (K) byte at the l^{th} stage. The output of the third AND logic device 3806 is active high if the base pointer points to a valid control (K) byte at the i^{th} stage, the chain pointer at the i^{th} stage points to a valid control (K) byte at the j^{th} stage, the chain pointer at the j^{th} stage points to a valid control (K) byte at the l^{th} stage, and the chain pointer at the l^{th} stage points to a non-valid control (K) byte at the m^{th} stage. This sequence may continue until pointers to all bytes are considered as shown in FIG. 38. The OR logic device 3816 logically OR's the outputs of all of the AND logic devices 3802, 3804, 3806, 3808, 3810, 3812, and 3814 to generate the third error detected signal (ed3).

At this point it should be noted that disparity bounding coding in multi-PAM signaling systems in accordance with the present disclosure as described above may involve the processing of input data and the generation of output data to some extent. This input data processing and output data generation may be implemented in hardware or software. For example, as described above, specific electronic components may be employed in an encoder, decoder, or other similar or related circuitry for implementing the functions associated with disparity bounding coding in multi-PAM signaling systems in accordance with the present disclosure as described above. Alternatively, one or more processors operating in accordance with stored instructions may implement the functions associated with disparity bounding coding in multi-PAM signaling systems in accordance with the present disclosure as described above. If such is the case, it is within the scope of the present disclosure that such instructions may be stored on one or more processor readable carriers (e.g., a magnetic disk), or transmitted to one or more processors via one or more signals.

The present disclosure is not to be limited in scope by the specific embodiments described herein. Indeed, other various modifications of and modifications to the present disclosure, in addition to those described herein, will be apparent to those of ordinary skill in the art from the foregoing description and accompanying drawings. Thus, such other embodiments and modifications are intended to fall within the scope of the following appended claims. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A method for coding information for transmission in a multi-level signaling system, the method comprising the steps of:
receiving information organized into multiple information sets;
mapping the received information according to the contents of each information set; and
changing a current weight polarity of the mapped information based at least in part upon an accumulated weight polarity of previously encoded information so as to provide a substantially DC balanced codeword that is substantially DC balanced for transmission in a multi-level signaling system.

2. The method of claim 1, wherein the received information is organized into 8 bytes each having 8 bits.

3. The method of claim 1, wherein all of the received information is data information.

4. The method of claim 1, wherein all of the received information is control information.

5. The method of claim 1, wherein the received information comprises data information and control information.

6. The method of claim 1, wherein the step of mapping comprises:
adding base pointer bits to the received information.

7. The method of claim 6, wherein the base pointer bits indicate a position of a control byte within the mapped information.

8. The method of claim 7, wherein the control byte comprises a control value field and a control chain pointer field.

9. The method of claim 8, wherein the control byte is the only control byte within the mapped information, and wherein the control chain pointer field is set to a control chain pointer field value which indicates that there are no other control bytes within the mapped information.

10. The method of claim 8, wherein the control byte is a first control byte within the mapped information, and wherein the control chain pointer field within the first control byte is set to a control chain pointer field value which indicates a position of a second control byte within the mapped information.

11. The method of claim 6, wherein the base pointer bits indicate that all of the received information is data information.

12. The method of claim 6, wherein the step of mapping further comprises:
adding a parity bit to the received information.

13. The method of claim 1, wherein the current weight polarity of the mapped information is changed by reversing the current weight polarity of the mapped information.

14. The method of claim 1, wherein the codeword is transmitted at four signal levels on a single transmission medium.

15. The method of claim 14, wherein the single transmission medium comprises a single electrical conductor.

16. The method of claim 14, wherein the single transmission medium comprises a differential pair of electrical conductors.

17. The method of claim 14, wherein the single transmission medium comprises an optical fiber.

18. The method of claim 14, further comprising the steps of:
receiving the transmitted codeword; and
detecting the reversal of the current weight polarity of the mapped information in the received codeword.

19. The method of claim 18, further comprising the step of:
reversing the current weight polarity of the mapped information in the received codeword so as to return the codeword to an original mapped information state.

20. The method of claim 19, further comprising the step of:
demapping the received codeword after the current weight polarity of the mapped information in the received codeword is reversed.

21. At least one signal embodied in at least one carrier wave for transmitting a computer program of instructions configured to be readable by at least one processor for instructing the at least one processor to execute a computer process for performing the method as recited in claim 1.

22. At least one processor readable carrier for storing a computer program of instructions configured to be readable by at least one processor for instructing the at least one processor to execute a computer process for performing the method as recited in claim 1.

23. An apparatus for coding information for transmission in a multi-level signaling system, the apparatus comprising:
a mapper configured to map received information organized into multiple information sets according to the contents of each information set; and
a DC balancer configured to change a current weight polarity of the mapped information based at least in part upon an accumulated weight polarity of previously encoded information so as to provide a substantially DC balanced codeword that is substantially DC balanced for transmission in a multi-level signaling system.

24. The apparatus of claim 23, wherein the received information is organized into 8 bytes each having 8 bits.

25. The apparatus of claim 23, wherein all of the received information is data information.

26. The apparatus of claim 23, wherein all of the received information is control information.

27. The apparatus of claim 23, wherein the received information comprises data information and control information.

28. The apparatus of claim 23, wherein the mapper is also configured to add base pointer bits to the received information.

29. The apparatus of claim 28, wherein the base pointer bits indicate a position of a control byte within the mapped information.

30. The apparatus of claim 29, wherein the control byte comprises a control value field and a control chain pointer field.

31. The apparatus of claim 30, wherein the control byte is the only control byte within the mapped information, and wherein the control chain pointer field is set to a control chain pointer field value which indicates that there are no other control bytes within the mapped information.

32. The apparatus of claim 30, wherein the control byte is a first control byte within the mapped information, and wherein the control chain pointer field within the first control byte is set to a control chain pointer field value which indicates a position of a second control byte within the mapped information.

33. The apparatus of claim 28, wherein the base pointer bits indicate that all of the received information is data information.

34. The apparatus of claim 28, wherein the mapper is further configured to add a parity bit to the received information.

35. The apparatus of claim 23, wherein the current weight polarity of the mapped information is changed by reversing the current weight polarity of the mapped information.

36. The apparatus of claim 23, wherein the codeword is transmitted at four signal levels on a single transmission medium.

37. The apparatus of claim 36, wherein the single transmission medium comprises a single electrical conductor.

38. The apparatus of claim 36, wherein the single transmission medium comprises a differential pair of electrical conductors.

39. The apparatus of claim 36, wherein the single transmission medium comprises an optical fiber.

40. The apparatus of claim 36, further comprising:
a detector configured to receiving the transmitted codeword and detect the reversal of the current weight polarity of the mapped information in the received codeword.

41. The apparatus of claim 40, wherein the detector is further configured to reverse the current weight polarity of the mapped information in the received codeword so as to return the codeword to an original mapped information state.

42. The apparatus of claim 41, wherein the detector is further configured to demap the received codeword after the current weight polarity of the mapped information in the received codeword is reversed.

43. An apparatus for coding information for transmission in a multi-level signaling system, the apparatus comprising:
means for mapping received information organized into multiple information sets according to the contents of each information set; and
means for changing a current weight polarity of the mapped information based at least in part upon an accumulated weight polarity of previously encoded information so as to provide a substantially DC balanced codeword that is substantially DC balanced for transmission in a multi-level signaling system.
